(19) United States
(12) Patent Application Publication
(10) Pub. No.: US 2007/0222743 A1
(43) Pub. Date: Sep. 27, 2007

(54) Liquid crystal display

(75) Inventor: Junichi Hirakata, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/723,633

(22) Filed: Mar. 21, 2007

(30) Foreign Application Priority Data
Mar. 22, 2006 (JP) 2006-079288

(51) Int. Cl. G09G 3/36

(52) U.S. Cl. 345/102

(57) ABSTRACT

A liquid crystal display is provided and includes: a liquid crystal panel; light sources for illuminate light from M kinds of colors onto the liquid crystal panel; and a light source driving unit in which a one-frame period of an input image signal is divided into M or more subfields, and the light sources are sequentially driven in a time-sharing mode in correspondence with the subfields. The light source driving unit changes in correspondence with the input image signal at least one of an emission intensity and an emission period of a light source in a period of the subfield and the number of emission times of the light source during the one-frame period. Alternatively, a liquid crystal driving unit performs gradation control for changing a gradation characteristic independently with respect to each of the light sources, the gradation characteristic representing a relationship of emission intensity of each of the light sources with respect to the input image signal. The maximum luminance of a specific color in the subfield is thereby changed.

### BACKGROUND OF THE INVENTION

1. Field of the Invention

The present invention relates to a liquid crystal display, and more particularly to a technique for improving color reproducibility and dynamic contrast.

2. Description of Related Art

Cathode ray tubes (CRTs) have hitherto been mainly used as displays employed in office automation (OA) equipment such as word processors, laptop computers, and monitors for personal computers, portable terminals, televisions, and the like. In recent years, however, liquid crystal displays have come to be used widely instead of the CRTs.

The displays using liquid crystal display devices (also called liquid crystal display panels) are capable of displaying images without providing a space (vacuum housing) for the two-dimensional scanning of an electron beam on the rear side of a display screen as in the cathode ray tube (CRT). Accordingly, these displays have characteristics of being thinner, more lightweight, and lower in power consumption than the CRTs. These displays are, in some cases, referred to as “flat panel displays” in view of their characteristics of external appearance.

Because of the aforementioned advantages over the CRTs, the displays using the liquid crystal display devices are becoming widespread in various types of uses in substitution for the displays using the CRTs. The progress in the replacement of the CRTs by the flat panel displays is partly accounted for by technological innovation in the improvement of the image quality of liquid crystal display devices. Recently, there has been a growing demand for moving picture display due to the spread of multimedia and the Internet.

In the displays using the liquid crystal display devices, improvements have been made on liquid crystal materials and driving methods in order to implement the moving picture display. However, in order to display images comparable to those of CRTs, the implementation of a higher luminance and the improvement of a reproducible color gamut have also become important issues.

To obtain the display of moving pictures comparable to those of the CRT, an impulse-type light emission is essential in which each pixel is scanned with an electron beam radiated from an electron gun to cause the phosphor at each pixel to emit light. In contrast, the liquid crystal displays employ a hold-type light emission which uses a backlight system including one or more fluorescent lamps. Because of this, it has been regarded as difficult for the liquid crystal displays to implement complete moving picture display.

As techniques for solving the above-described issues related to the liquid crystal displays, the following have been reported: Improvements in the liquid crystal material or in the display mode of liquid crystal cells (i.e., a liquid crystal layer sealed between two substrates), and methods of using as a light source a backlight of a directly-below type (i.e., a light source structure in which a plurality of fluorescent lamps are disposed in face-to-face relation to the display screen of the liquid crystal display).

FIGS. 16A and 16B are diagrams illustrating an example of a lighting operation method for the backlight of the directly-below type proposed for the moving picture display. FIG. 16A is a diagram illustrating the layout of the backlight of the directly-below type in which eight tubular fluorescent lamps are disposed in face-to-face relation to the display screen (the dotted-line frame). FIG. 16B is a diagram illustrating as drive waveforms timings of lighting starting times for the respective lamps. The drive waveforms illustrated in FIG. 16B indicate that the luminance rises when a voltage of a predetermined level is applied.

As shown in FIG. 16B, the lighting starting time for each fluorescent tube is shifted in sequence from the fluorescent tube located on one end side to the fluorescent tube located on the other end side. This sequential lighting operation is synchronized with a scanning period of an image display signal, and is repeated for each image display time period of one frame (i.e., a time period during which video signals are sent to all the pixels on the display screen). As a result, it is possible to obtain an impulse-type light emission comparable to that of the CRT (refer to “Liquid Crystal”, Vol. 3, No. 2 (1999), pp. 99-106).

In a liquid crystal display using a backlight such as the one described above, a backlight consisting of, for example, three-wavelength cold-cathode fluorescent lamps and color filters are combined to effect color display. However, since the color filters effect color display through the absorption of light, their light transmittances are low, so that their efficiency of use as display lights has been low. Accordingly, as a display system which does not use the absorption type color filters, a liquid crystal display has been proposed in which backlight sources having emission spectra of three primary colors of the RGB light are sequentially blinked at high speed (refer to JP-A-2001-290121).

Here, a description will be given of a commonly used field sequential method.

Systems for full-color display using liquid crystal displays include a spatial mixture system and a time difference mixture system, the latter being referred to as the field sequential system.

The spatial mixture system has as its basic principle an additive color mixture in which light components in the wavelength regions of red (R), green (G), and blue (B) are superposed. In an LCD, pixels which respectively emit the light of R, G, and B are disposed in close proximity to each other, and luminances of the respective pixels are varied so as to mix these colors arbitrarily, thereby obtaining arbitrary colored light. In addition, color filters are generally used in the LCDs based on the spatial mixture system.

The field sequential system is a color display system which makes use of a color mixture based on “time sharing.” Namely, this is a system to which is applied a human visual perception whereby if light beams of two or more colors are emitted by being continually switched over, and the switching speed is set to a speed which exceeds a human eye's temporal resolution, the human eye mixes the aforementioned two or more colors and perceives them as one color. In the full-color LCD of the field sequential system, the backlight is made capable of emitting one emission color among the three emission colors of R, G, and B for each field in the moving picture display, and the emission colors of R, G, and B are emitted by being switched over (time-shared) continually for each field, and the switching speed is made sufficiently fast so as to obtain arbitrary colored light.

FIGS. 17A and 17B are diagrams illustrating examples of the driving mode of the backlight of the directly-below type proposed for the moving picture display. FIG. 17A is a diagram illustrating an example of the method of driving a backlight constituted by a white cold-cathode tube in the background art. FIG. 17B is a diagram illustrating an example of the method of driving a field sequential backlight constituted by RGB three-color light sources.

Color filters are generally used in the LCD with the background art backlight shown in FIG. 17A. As predetermined liquid crystals are driven during a one-frame period while the backlight is emitting white light, full-color display is carried out through the transmission and shielding of light by the desired color filters. Meanwhile, in the full-color LCD of the field sequential system shown in FIG. 17B, each field of color is divided into a state of being spectrally separated into an R subfield, a G subfield, and a B subfield. When the field of one color is displayed, the aforementioned subfields of R, G, and B with temporal differences sequentially imparted thereto are displayed on the LCD. When the R subfield is displayed, the light emission of the backlight is set to red (R); when the B subfield is displayed, the light emission of the backlight is set to blue (B); and when the G subfield is displayed, the light emission of the backlight is set to green (G). The above-described LCD is capable of displaying moving pictures in color as the color fields each consisting of the three-color subfields time-divided in the above-described manner are continually displayed while sequentially switching over the three emission colors.

In the LCD with the backlight of the background art, if color filters are introduced, the light from the backlight is substantially absorbed by the color filters. However, in the field sequential system which does not require the color filters, it is possible to suppress the power consumption incurred in the loss of light by the portion it is absorbed by the color filters, and low power consumption is possible in comparison with the LCDs of the background art. Further, the color filters are expensive among the costs of members of the color liquid crystal display panel, and it is possible to attain a substantial reduction in cost by eliminating the color filters.

In the field sequential system, since it is necessary to cause light to be emitted by switching over each subfield to each of R, G, and B sufficiently fast, both the backlight and the liquid crystal display panel constituting the LCD need to be capable of high speed response as compared with those of LCDs in the background art. Namely, it is said that the field needs to be switched over in approximately 1/60 second or less in order to ensure that the flicker of images due to the changeover of the color does not occur. Therefore, it is necessary to switch over in approximately 1/180 second or less, i.e., 6 milliseconds or less in order to effect the display of one color per field. Furthermore, the writing of an image, the response of the liquid crystal, and the lighting of the backlight need to be performed within this field, so that the liquid crystal display panel is required to be driven with an even faster speed.

However, liquid crystal displays are new type liquid crystal displays under development, and in order to further improve the image quality of display images, there are numerous tasks to be solved, including the optimization of conditions of driving the backlight sources, improvement of drive signals for the liquid crystal, and selection of a material suited for the high-speed driving of the element itself. In particular, an urgent need is to improve the displayable contrast and improve the dynamic display characteristic while enhancing the color reproducibility of display images.

### SUMMARY OF THE INVENTION

One aspect of an illustrative, non-limiting embodiment of the invention is to provide a liquid crystal display which is capable of high image quality display by enhancing the color reproducibility and increasing the dynamic contrast.

The above aspect of the invention can be achieved by the following configurations:

(1) A liquid crystal display comprising: a liquid crystal panel capable of selectively forming a light transmitting state or a light shielding state in correspondence with an alignment direction of a liquid crystal; light sources of M (M is a natural number of 3 or more) kinds of mutually different colors, each of the light sources illuminating light onto the liquid crystal panel; and a light source driving unit in which a one-frame period of an input image signal is divided into M or more subfields, and the light sources are sequentially driven in a time-sharing mode in correspondence with the subfields, wherein the light source driving unit changes in correspondence with the input image signal at least one of: an emission intensity in a period of a subfield of the M or more subfields; an emission period in the period of the subfield; and the number of emission times during the one-frame period with respect to a light source, to thereby change the maximum luminance of at least one specific color corresponding to the light source in the subfield.

According to this liquid crystal display, the light source driving unit changes in correspondence with the input image signal at least one of the emission intensity in the subfield, the emission period in the subfield and the number of emission times during the one-frame period with respect to a light source, thereby making it possible to change a maximum luminance of a specific color corresponding to the light source in the subfield. As a result, the specific color is enhanced, so that a display image with a large dynamic contrast can be obtained, and unprecedentedly high image quality can be achieved.

(2) A liquid crystal display comprising: a liquid crystal panel capable of selectively forming a light transmitting state or a light shielding state in correspondence with an alignment direction of a liquid crystal; light sources of M (M is a natural number of 3 or more) kinds of mutually different colors, each of the light sources illuminating light onto the liquid crystal panel from a side opposite to a display side of the liquid crystal panel; a light source driving unit in which a one-frame period of an input image signal is divided into M or more subfields, and the light sources are sequentially driven in a time-sharing mode in correspondence with the subfields; and a liquid crystal driving unit for driving the liquid crystal panel, wherein the liquid crystal driving unit performs gradation control for changing a gradation characteristic independently with respect to each of the light sources, the gradation characteristic representing a relationship of emission intensity of each of the light sources with respect to the input image signal, to thereby change a maximum luminance of at least one specific color in the subfield.

According to this liquid crystal display, the liquid crystal driving unit performs gradation control for changing a gradation characteristic independently with respect to each of the light sources, the gradation characteristic representing a relationship of emission intensity of each of the light sources with respect to the input image signal, thereby making it possible to finely set the display luminance for each color. Since the maximum luminance of a specific color in the subfield can be changed, the specific color is enhanced, so that a display image with a large dynamic contrast can be obtained, and unprecedentedly high image quality can be achieved. For example, in a case where the blue sky in the background of an input image is to be enhanced, blue is enhanced by such as the intensity adjustment of the light sources, and the gradient of the gradation characteristic or the intensity ratio among red, green, and blue are dynamically changed. Thus, it is possible to enhance, for instance, the contour of the blue sky, thereby making it possible to achieve further improvement of the image quality.

(3) A liquid crystal display comprising: a liquid crystal panel capable of selectively forming a light transmitting state or a light shielding state in correspondence with an alignment direction of a liquid crystal; light sources of M (M is a natural number of 3 or more) kinds of mutually different colors, each of the light sources illuminating light onto the liquid crystal panel; a light source driving unit in which a one-frame period of an input image signal is divided into M or more subfields, and the light sources are sequentially driven in a time-sharing mode in correspondence with the subfields; and a liquid crystal driving unit for driving the liquid crystal panel, wherein the light source driving unit changes in correspondence with the input image signal at least one of: an emission intensity in a period of a subfield of the M or more subfields; an emission period in the period of the subfield; and the number of emission times during the one-frame period with respect to a light source, and wherein the liquid crystal driving unit performs gradation control for changing a gradation characteristic independently with respect to each of the light sources, the gradation characteristic representing a relationship of emission intensity of each of the light sources with respect to the input image signal, to thereby change a maximum luminance of at least one specific color in the subfield.

According to this liquid crystal display, the light source driving unit changes in correspondence with the input image signal at least one of: an emission intensity in a period of a subfield of the M or more subfields; an emission period in the period of the subfield; and the number of emission times during the one-frame period with respect to a light source, thereby making it possible to change the maximum luminance of a specific color in the subfield. As a result, the specific color is enhanced, so that a display image with a large dynamic contrast can be obtained. In addition, the liquid crystal driving unit performs gradation control for changing a gradation characteristic independently with respect to each of the light sources, the gradation characteristic representing a relationship of emission intensity of each of the light sources with respect to the input image signal, thereby making it possible to finely set the display luminance for each color. Since the maximum luminance of a specific color in the subfield can be changed, the specific color is enhanced, so that a display image with a large dynamic contrast can be obtained, and unprecedentedly high image quality can be achieved.

(4) The liquid crystal display according to (1) or (3), further comprising a number-of-emission controlling unit which, at the time of dynamically changing the number of emission times of each of the light sources during the one-frame period, divides the one-frame period into (M+n) (n is a positive integer) subfields, allots the periods of emission by the light sources of the M kinds of colors, respectively, once in the one-frame period, and additionally allots an emission period for the light source corresponding to the specific color among the light sources of the M kinds of colors.

According to this liquid crystal display, the division into (M+n) subfields is executed under the light sources of M kinds of colors (in principle, after lighting peak values (maximum luminances) and light-on periods of the light sources in the respective subfields are all set to be identical), and the light sources of the M colors are made to emit light in a predetermined sequence in 1st to M-th subfields. Further, a dynamic change is made concerning to which color the final (M+n)th subfield is to be allotted. By virtue of this configuration, the light-on period, as viewed from the one whole frame, of an arbitrary color among the M colors becomes longer than the turn-on periods of the other colors, and therefore a predetermined color can be enhanced with a simple configuration.

(5) The liquid crystal display according to (4), wherein the number-of-emission controlling unit comprises: a pulse generating circuit for continually generating, at intervals, (M+n) (n is a positive integer) pulses used in the drive of the light sources; and a pulse supplying circuit for supplying each of 1st to M-th pulses among the (M+n) pulses to drive circuits for driving the light sources of the respective colors as pulses for driving the M kinds of colors, and for selectively supplying each of (M+n)th pulses to any one of the drive circuits for driving the light sources of the respective colors.

According to this liquid crystal display, (M+n) pulses having identical peak values and pulse widths are continually generated, the 1st to M-th pulses are supplied to the drive circuits of the respective colors in a sequence, and the final pulse is distributed to the drive circuit of the color to be enhanced (in short, by switching over the supply destination of the pulses). Thus, the enhancement of a desired color becomes possible, and a display with a color enhanced becomes possible with circuitry having a simple configuration.

(6) The liquid crystal display according to any one of (1) to (5), wherein, with respect to each of pixels constituting a display image in the one-frame period of the input image signal, color information of each of the pixels is determined, and a color having a largest occurrence frequency in the display image is set as the specific color.

According to this liquid crystal display, a color having a largest occurrence frequency in the display image is set as the specific color as the color to be enhanced, and this specific color is subjected to enhancement processing, thereby making it possible to provide image display of high image quality.

(7) The liquid crystal display according to (2) or (3), further comprising an image quality adjusting unit for subjecting a display image in the one-frame period of the input image signal to color enhancement processing for increasing a gain of the specific color.

According to this liquid crystal display, concerning an input image signal serving as a display image on the liquid crystal panel, the gamma characteristic in a tone curve of a specific color is increased, with the result that the specific color can be enhanced.

(8) The liquid crystal display according to any one of (1) to (7), wherein the light source driving unit changes light emitting state of the light source corresponding to the specific color in a specific portion of the display image so as to perform color enhancement processing for forming an emission intensity distribution.

According to this liquid crystal display, the emission intensity can be provided with a distribution in a display image region, so that the image quality of one whole image can be effectively improved.

(9) The liquid crystal display according to any one of (1) to (8), wherein each of time periods of turning on and turning off of the light sources of the M kinds of colors in the subfield period is longer than a response time at at least one of the rise and fall, after application of an electric field, of the liquid crystal used in the liquid crystal panel.

According to this liquid crystal display, the luminance waveform of the liquid crystal is able to completely follow the lighting luminance of the light source, so that a sufficient dynamic contrast can be obtained. Further, drawbacks such as the generation of afterglow do not occur, so that it is possible to realize a liquid crystal display excelling in the moving picture performance.

(10) The liquid crystal display according to any one of (1) to (9), wherein the liquid crystal used in the liquid crystal panel includes an OCB (optical compensated birefringence) liquid crystal in a bend alignment.

According to this liquid crystal display, by the use of the OCB liquid crystal capable of high-speed response, the above-described dynamic color management system can be realized, and the image quality of the display image of the liquid crystal display can be sufficiently improved.

### BRIEF DESCRIPTION OF THE DRAWINGS

The features of the invention will appear more fully upon consideration of the exemplary embodiments of the invention, which are schematically set forth in the drawings, in which:

FIG. 1 is a block diagram illustrating an overall configuration of a liquid crystal display in accordance with an exemplary embodiment of the invention in which the dynamic color management system is adopted;

FIGS. 2A to 2D are explanatory diagrams illustrating an example in which light sources are dynamically driven to enhance a particular display color;

FIG. 3 is a circuit diagram illustrating an example of the configuration of light source driving circuits in accordance with an emission intensity modulation system;

FIG. 4 is a circuit diagram illustrating an example of the configuration of the light source driving circuits in accordance with a pulse width modulation system;

FIGS. 5A to 5E are explanatory diagrams illustrating a sequential drive system in which the number of emission times of each color during a one-frame period is dynamically changed;

FIG. 6 is a circuit diagram illustrating an example of the configuration of the light source driving circuits of the system in which the number of emission times during the one-frame period is changed;

FIG. 7 is a diagram illustrating waveforms of major signals and their timings for explaining the operation of the circuitry shown in FIG. 6;

FIGS. 8A to 8D are explanatory diagrams illustrating an example in which control of the backlight sources and gradation control of a display image are executed simultaneously;

FIGS. 9A to 9D are explanatory diagrams illustrating a method of optimizing the driving of light sources from the perspective of the response speed of the liquid crystal cell;

FIG. 10 is a schematic diagram as one example of the configuration of a liquid crystal display in accordance with t an exemplary embodiment of the invention;

FIGS. 11A to 11F are diagrams illustrating examples of the layout of LEDs in a case where the LEDs are used as the backlight sources;

FIGS. 12A and 12B are diagrams illustrating examples of the configuration of the backlight, in which FIG. 12A is a diagram illustrating the configuration of a directly-below type, and FIG. 12B is a diagram illustrating the configuration of a side edge type;

FIG. 13 is a diagram illustrating the configuration of a backlight using light sources arranged in box-shapes;

FIG. 14 is a diagram illustrating the configuration of a backlight in which cold-cathode tubes and LEDs are combined;

FIGS. 15A and 15B are diagrams illustrating examples of a reproducible color gamut in the CIE color system (color space), in which FIG. 15A is a diagram illustrating a reproducible color gamut of a liquid crystal display using cold-cathode tubes, and FIG. 15B is a diagram illustrating a reproducible color gamut of a liquid crystal display using the combination of cold-cathode tubes and LEDs which are YMC light sources;

FIGS. 16A and 16B are diagrams illustrating an example of a lighting operation method for the backlight of the directly-below type proposed for the moving picture display, in which FIG. 16A is a diagram illustrating the layout of the backlight of the directly-below type in which eight tubular fluorescent lamps are disposed in face-to-face relation to the display screen (the dotted-line frame), and FIG. 16B is a diagram illustrating as drive waveforms timings of lighting starting times for the respective lamps; and

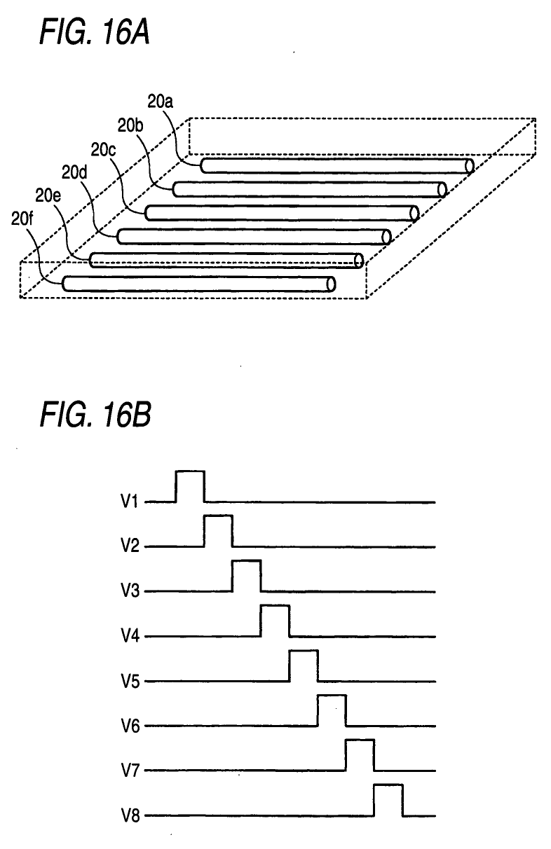

FIGS. 17A and 17B are diagrams illustrating examples of the driving mode of the backlight of the directly-below type proposed for the moving picture display, in which FIG. 17A is a diagram illustrating an example of the method of driving a backlight constituted by a white cold-cathode tube in the background art, and FIG. 17B is a diagram illustrating an example of the method of driving a field sequential backlight constituted by RGB three-color light sources.

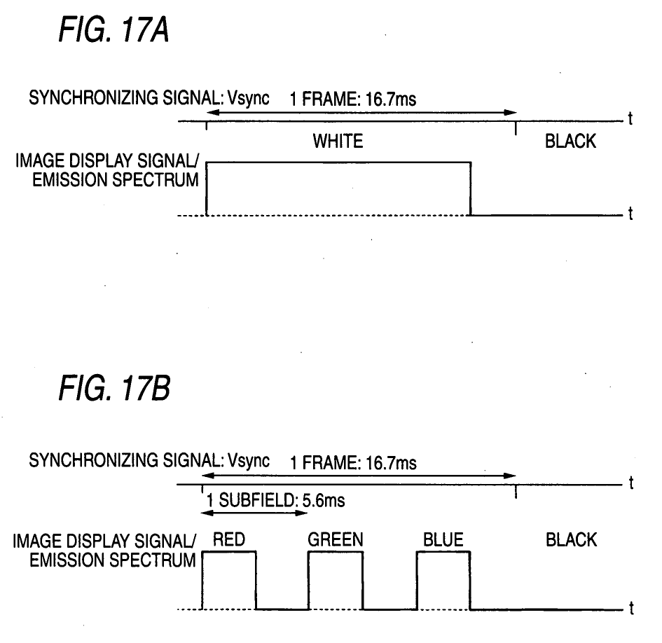

### SOME OF REFERENCE NUMERALS AND SIGNS IN THE DRAWINGS ARE SET FORTH BELOW

100: color data detecting and computing circuit
102: color data separation circuit
104: comparison operation circuit
106: color data conversion circuit
200: image quality control circuit
202: contrast control circuit
204: DC level control circuit
206: digital γ control circuit
300: luminance detecting and setting circuit
302: mean value detecting circuit
304: maximum value detecting circuit
306: minimum value detecting circuit
500: light source lighting circuit
400: panel controller
410, 420: LCD drivers
600: liquid crystal panel
700a to 700f: LED rows serving as backlight sources disposed immediately below the panel

### DETAILED DESCRIPTION OF THE EXEMPLARY EMBODIMENTS

Although the invention will be described below with reference to the exemplary embodiments thereof, the following exemplary embodiments and modifications do not restrict the invention.

According to an exemplary embodiment of the invention, by adopting the dynamic color management system in which one of the intensity, the light-on period, and the number of light turning-on times of each light source, unprecedentedly high image quality of the liquid crystal display can be attained.

Referring now to the accompanying drawings, a detailed description will be given of liquid crystal displays in accordance with exemplary embodiments of the invention.

In self-emissive displays such as CRTs and PDPs, black display is devoid of emission itself, and therefore black in black display is perceived to be of lower luminance, imparting an impression that the contrast is high. This characteristic will be referred to herein as the dynamic display characteristic. On the other hand, in LCDs, the light sources are always lit continuously even if the display image is being displayed in white or black. For this reason, the light from the light sources leaks even during black display, and the contrast is perceived to be low in some cases. As a method of improving the dynamic contrast characteristic in the LCD, a method has been proposed in which the brightness of the light source is changed in correspondence with the input image. Namely, when there are many dark image signals in the input signals, the brightness of the light source is made low, whereas when there are many bright image signals, the brightness of the light source is made high to thereby increase the dynamic contrast. The above-described method, however, involves only control of the contrast, and in order to obtain more vivid images, particularly the moving picture display, control of color management is required, which becomes more complex.

Accordingly, in the liquid crystal display in accordance with the invention, the dynamic color management system is adopted in which any one of the intensity of the light source, the light-on period, and the number of lighting times is dynamically controlled in one-pixel units, whereby high image quality unprecedented in the field sequential type liquid crystal displays of the background art is attained.

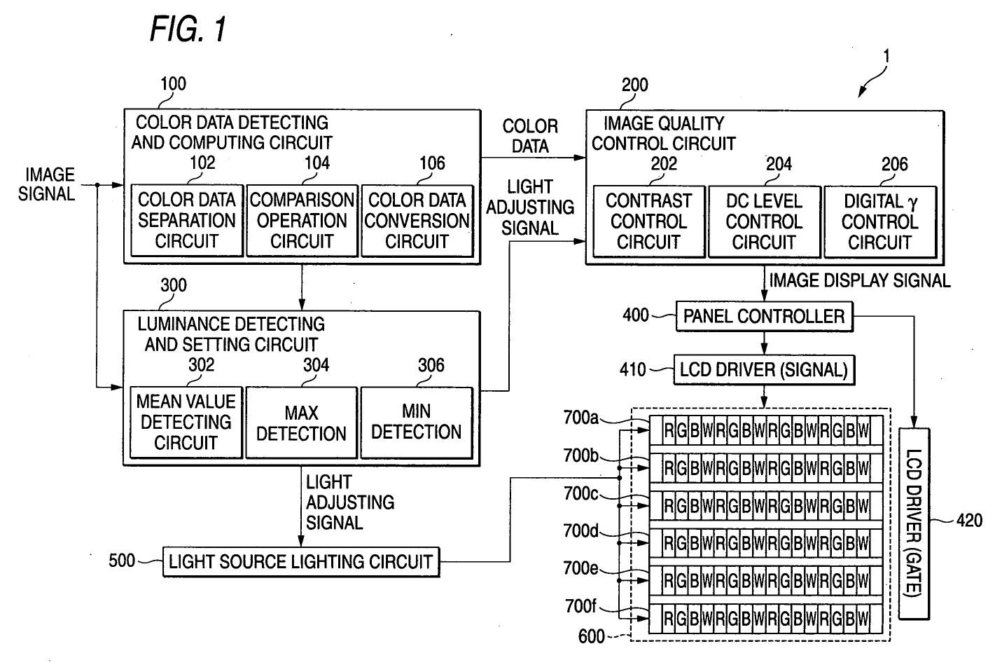

FIG. 1 is a block diagram illustrating an overall configuration as an example of the liquid crystal display in accordance with the invention in which the dynamic color management system is adopted.

A liquid crystal display 1 is comprised of a color data detecting and computing circuit 100, an image quality control circuit 200, a luminance detecting and setting circuit 300, a light source lighting circuit 500, and a liquid crystal module (including a panel controller 400, LCD drivers 410 and 420, a liquid crystal panel 600, and LED rows 700a to 700f serving as light sources disposed immediately below the panel).

The color data detecting and computing circuit 100 is configured by including a color data separation circuit 102, a comparison operation circuit 104, and a color data conversion circuit 106. Further, the image quality control circuit 200 is configured by including a contrast control circuit 202, a DC level control circuit 204, and a digital γ control circuit 206.

In addition, the luminance detecting and setting circuit 300 is configured by including a mean value detecting circuit 302, a maximum value detecting circuit 304, and a minimum value detecting circuit 306.

The input image signal is inputted to the color data detecting and computing circuit 100 and the luminance detecting and setting circuit 300.

As the input image signal, various signals are assumed including an analog signal, a digital signal, and the like. First, the color data detecting and computing circuit 100 performs gradation data decomposition for R, G, and B of the respective pixels during the one-frame period, and prepares occurrence frequency histograms for the respective colors to thereby detect relative frequencies of the numbers of colors in the entire screen (e.g., which color of R, G, and B is predominant in the display). In addition, the color data detecting and computing circuit 100 performs calculation of the gradation whose number of data is large, and sends information on the display color and gradation to be enhanced to the image quality control circuit 200 and the luminance detecting and setting circuit 300.

In addition, the luminance detecting and setting circuit 300 calculates a maximum value, a minimum value, and a mean value of the luminance of each pixel in one frame. Further, the luminance detecting and setting circuit 300 compares these values between the preceding and following frames, generates a light adjustment signal (a control signal for causing the light source to emit light so as to obtain an optimum display image) on the basis of analysis thereof, and sends this light adjustment signal to the image quality control circuit 200 and the light source lighting circuit 500.

The image quality control circuit 200 serving as an image quality adjusting unit prepares image display signals to be supplied to the entire screen and to the respective pixels on the basis of the color data (the signals from the color data detecting and computing circuit 100) and the luminance data (the signals from the luminance detecting and setting circuit 300) sent thereto, and imparts the image display signals to the panel controller 400 of the liquid crystal module.

In addition, the light source lighting circuit 500 serving as a number-of-emission controlling unit operates in accordance with the light adjustment signal (a control signal generated on the basis of the color data and luminance data for each frame) from the luminance detecting and setting circuit 300, generates drive signals for the respective LEDs in the LED rows (700a to 700f) of M colors (M is a natural number; three colors of R, G, and B in this embodiment), and supplies these drive signals to the respective LEDs. It should be noted that although LEDs of W (white) are included among the LED rows 700a to 700f, this configuration is for improving the emission luminance and is not necessarily essential.

According to the liquid crystal display of such a dynamic color management system, it is possible to drive the light sources in the manner described below, for example.

### (Drive for Dynamically Changing the Peak Luminance or Emission Period)

As described before, the peak luminance characteristic is one reason that the dynamic display characteristics of the self-emissive displays such as CRTs and PDPs excel. The pixels of black display in the self-emissive display do not emit light, and only the pixels of white display emit light, so that the brightness of the white display pixels is perceived to be particularly high. In addition, in the CRTs, the emission luminance of one frame is controlled by the current value, and if the number of pixels of white display is large, the luminance of the pixels declines, whereas if the number of pixels of white display is small, the emission current can be concentrated, so that the luminance of the pixels becomes high and is perceived to be brighter. This characteristic is referred to as the peak luminance characteristic. With respect to an area of the screen which is to be enhanced, by increasing the luminance of the light sources it is possible to increase the brightness and enhance a display color.

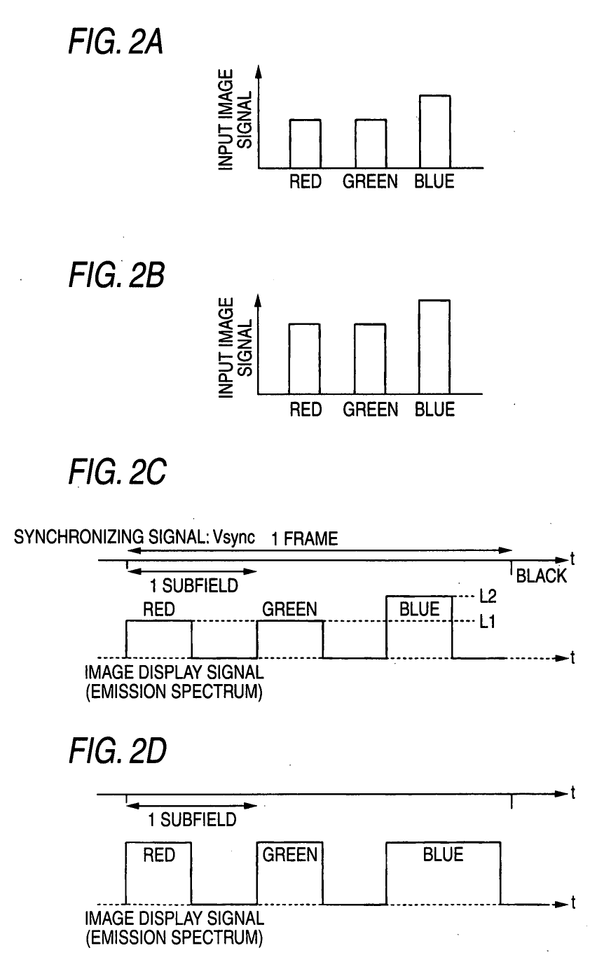

FIGS. 2A to 2D are explanatory diagrams illustrating an example in which the light sources are driven by being dynamically changed to enhance a particular display color. In FIGS. 2A to 2D, control shown in FIG. 2C is provided for input image signal levels shown in FIG. 2A, and control shown in FIG. 2D is provided for input image signal levels shown in FIG. 2B, which will be described in detail below.

First, FIG. 2A shows gradation levels of red (R), green (G), and blue (B) of the input image signal. When seen from these gradation levels, it is apparent that blue (B) is the color to be enhanced. To enhance the blue (B), in FIG. 2C, a one-frame period is divided into three subfields, and the respective subfields are allotted to the respective colors of R, G, and B. The LEDs of one color are lit in each subfield, and at the time of the lighting of the blue (B) LEDs the peak luminance value is changed from L1 to L2, thereby enhancing the blue (B) (the emission intensity modulation system in which the emission intensity of the LEDs is changed).

The signal levels shown in FIG. 2B are higher on the whole than in FIG. 2A, and the gradation of blue (B) is high. In FIG. 2D, the peak luminance values of the LEDs of the respective colors are set at the same levels, but the emission period of the blue (B) LEDs is made longer to enhance the blue (B) (the pulse width modulation system in which the drive pulse width of the LEDs is changed).

Here, a description will be given of examples of the configurations of the light source driving circuits in accordance with the above-described emission intensity modulation system and pulse width modulation system.

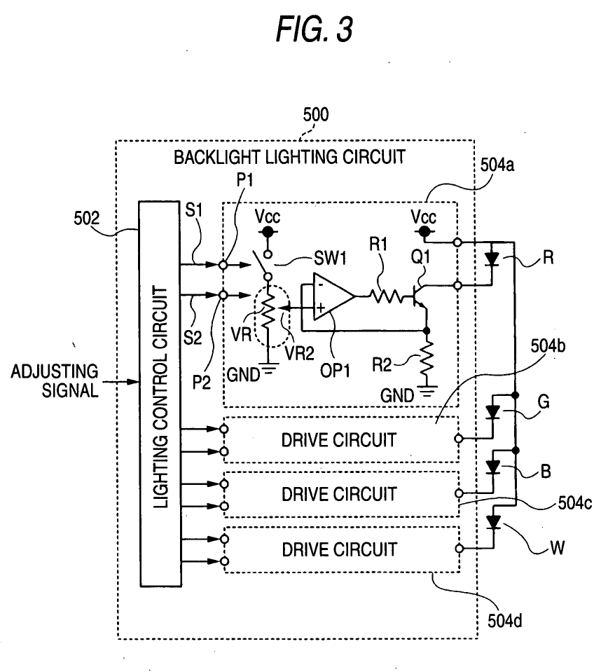

FIG. 3 is a circuit diagram illustrating an example of the configuration of the light source driving circuits in accordance with the emission intensity modulation system. In FIG. 3, R, G, B, and W indicate the LEDs of the respective colors, and the LEDs of the respective colors are driven by drive circuits 504a to 504d corresponding to the respective colors. The drive circuits 504a to 504d have similar configurations, and their operation is controlled by a lighting control circuit 502.

As for the drive circuits 504a to 504d, a description will be given herein by using the drive circuit 504a as an example. The drive circuit 504a is configured by including a switch (SW1) interposed between a power supply voltage (VCC) and a ground potential (GND); a variable resistor VR; a voltage follower (impedance converter) consisting of an operational amplifier OP1, a base resistor R1, and an NPN bipolar transistor Q1; and a voltage/current conversion resistor R2.

A voltage inputted to the voltage follower changes depending on at which position of the variable resistor VR a movable contact VR2 is, and the LED (R, G, B, W) of each color is driven by a current which is determined by dividing the output voltage of the voltage follower by a resistance value of the resistor R2.

The voltage which is outputted from the variable resistor VR can be varied, as required, by a control signal S2 which is imparted to a terminal P2 by the lighting control circuit 502, thereby making it possible to individually adjust the emission intensity of each LED.

In addition, the opening and closing of the switch SW1 can be individually controlled by a control signal S1 which is imparted to a terminal P1 by the lighting control circuit 502, thereby making it possible to effect the sequential driving (and control of the light-on period) of each LED.

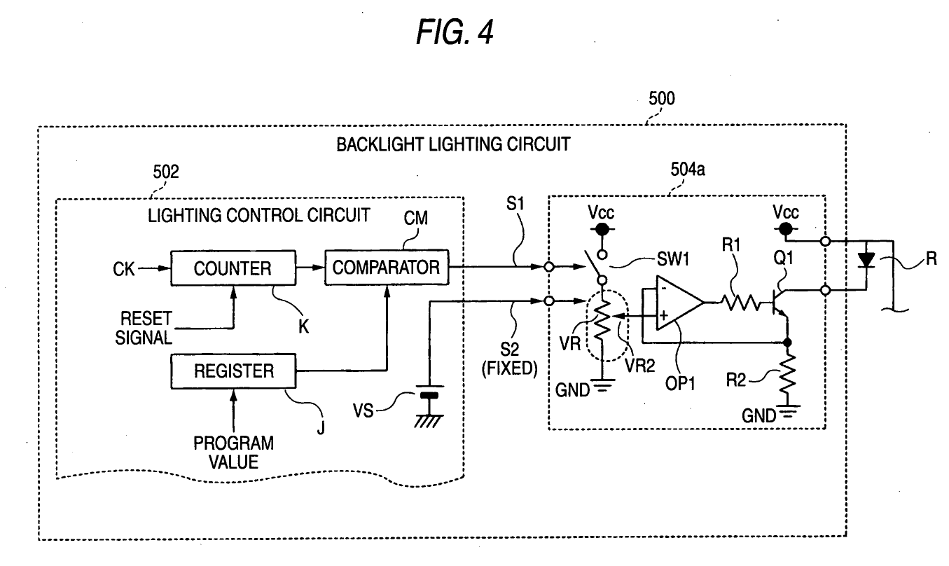

FIG. 4 is a circuit diagram illustrating an example of the configuration of the light source driving circuits in accordance with the pulse width modulation system. In FIG. 4 as well, the drive circuits 504a to 504d shown in FIG. 3 are used, but since the intensity modulation is not performed, the control signal S2 for controlling the variable resistor VR is fixed to a certain value. Instead, the control signal S1 is changed in the circuit shown in FIG. 4 to turn the switch SW1 on and off, whereby the duty of the drive pulse for the LED is dynamically changed so as to effect the enhancement of a specific color.

In addition, in FIG. 4, a pulse width modulation circuit consisting of a counter K, a register J, and a comparator CM is used to generate the control signal S1. After the counter K is reset and a programmed value is set in the register J, an operation clock CK is supplied to the counter K to start counting. The comparator CM outputs a high level when the count value of the counter K is smaller than the programmed value in the register J, and the comparator CM outputs a low level when the count value becomes equal to the programmed value. Accordingly, by appropriately changing the programmed value, the pulse width of the pulse outputted from the comparator can be changed arbitrarily. In consequence, this pulse width controls the light-on period of each LED of each color. Thus, it is possible to realize the dynamic lighting control of the LEDs.

### (Drive for Dynamically Changing the Emission Frequency of Each Color during One-Frame Period)

Although in the above-described example the emission intensity or the emission period is changed, in the following example the number of emission times of each color during the one-frame period is dynamically changed.

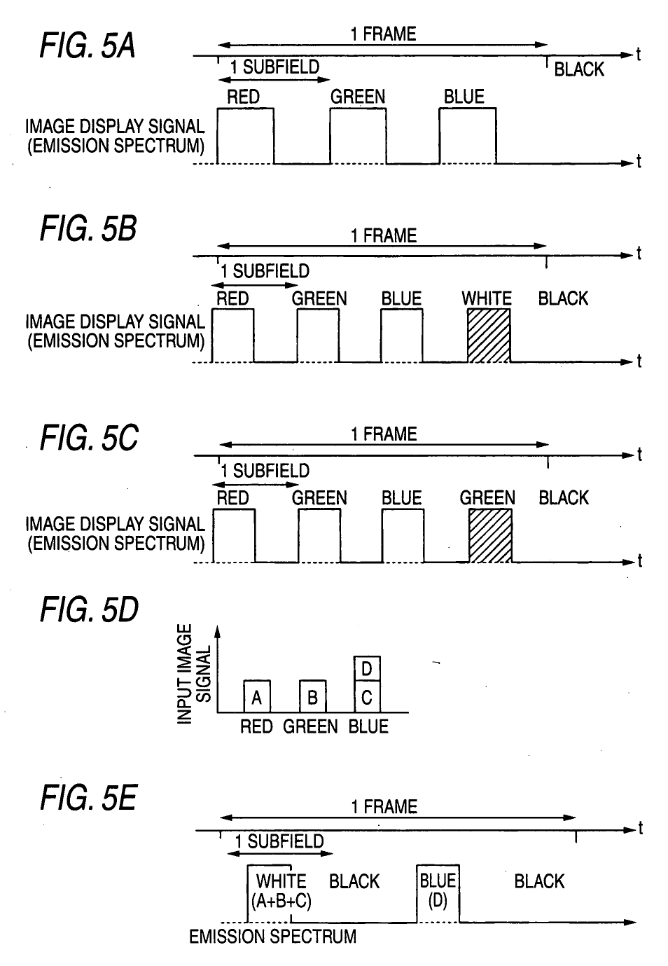

FIGS. 5A to 5E are explanatory diagrams illustrating the sequential drive system in which the number of emission times of each color during the one-frame period is dynamically changed.

In the field sequential system of the background art, as shown in FIG. 5A, one frame is divided in correspondence with the number of colors of the light sources (e.g., into three parts in correspondence with the three colors of R, G, and B), and the light sources are made to sequentially emit light. The luminance of the panel is dependent upon the light source luminance and the panel transmittance, and in a case where the enhancement of the RGB display colors is performed, it is possible to change the RGB ratio of the emission luminance of the light sources. However, the maximum luminance of the light source is an upper limit of the maximum value of the luminance, so that it has been impossible to enhance the brightness, and a more vivid color display has been difficult.

Accordingly, as a white light source lit up after the three colors of R, G, and B, as shown in FIG. 5B, the panel luminance can be made brighter. The image display signal at this time is converted into a color display signal corresponding to the spectrum and is sent to the panel controller to display the panel.

In addition, in the case of an image in which green is to be enhanced in the display image, G is made to emit light one more time than R and B, as shown in FIG. 5C. Namely, one frame, which is the period for displaying one screen, is divided into subfields in a number more than that of the M colors of the light sources, and after the display of M colors is given in correspondence with the input image signals, a particular light source is made to emit light in a subfield after the M colors in correspondence with the color of the image to be enhanced. By changing the order of emission of the M colors or changing the number of emission times in response to the input image signals without causing the light sources of the M colors to sequentially emit light, it becomes possible to control the color tone and the maximum luminance of the screen. In addition, although the light source of one color is blinked and made to emit light a plurality of times separately in a plurality of subfields, it is possible to rewrite the image signals an arbitrary number of M times in one frame.

In addition, in a case where the gradation level of blue (B) is high, and blue (B) is to be enhanced, as shown in FIG. 5D, W(=R+G+G; corresponding to (A+B+C) in FIG. 5D) may first be made to emit light, as shown in FIG. 5E, and a blue enhancement portion (corresponding to D in FIG. 5D) may be made to emit light in a subsequent subfield.

An example of the configuration of the light source driving circuits of the above-described system in which the number of emission times during the one-frame period is changed, is as follows.

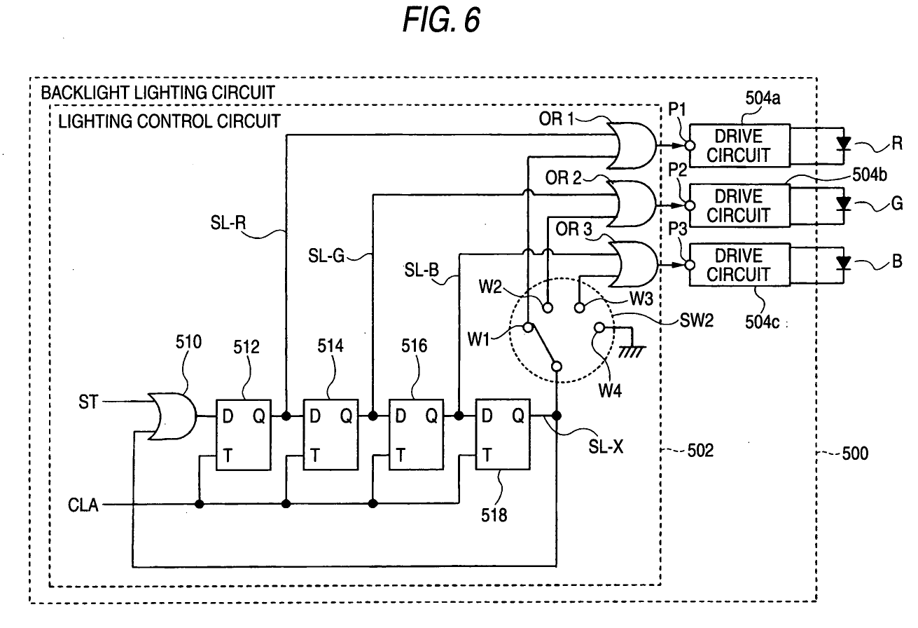

FIG. 6 shows a circuit diagram as an example of the configuration of the light source driving circuits of the above-described system in which the number of emission times during the one-frame period is changed.

As shown in the drawing, four-stage D-type flip-flops 512, 514, 516, and 518 (pulse generating circuits) are connected serially to configure a shift register. A lighting control pulse SL-R for the red (R) LED, a lighting control pulse SL-G for the green (G) LED, and a lighting control pulse SL-B for the blue (B) LED are sequentially outputted from the respective ones of the first to third D-type flip-flops 512, 514, and 516. The respective lighting control pulses are supplied to the terminals P1 to P3 of the drive circuits 504a to 504c (see FIG. 3 for the internal configuration) for the LEDs of the respective colors through OR circuits (OR1 to OR3).

Meanwhile, a pulse SL-X which is outputted from the fourth-stage D-type flip-flop 518 is supplied to any one of the drive circuits 504a to 504c for the LEDs of the respective colors via a pulse-distributing switch SW2 (pulse supplying circuit). By dynamically controlling the switching of this switch SW2, the enhancement of a desired color becomes possible.

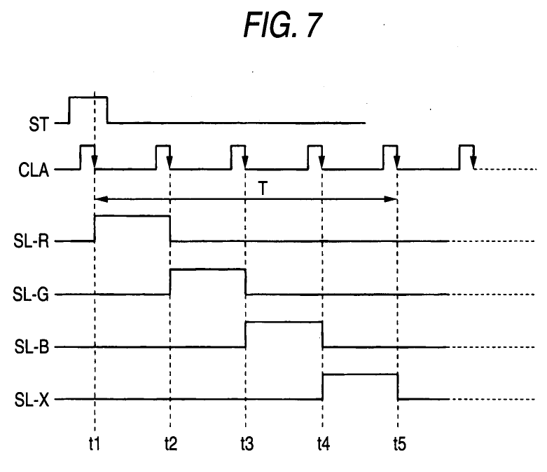

FIG. 7 is a diagram illustrating waveforms of major signals and their timings for explaining the operation of the circuitry shown in FIG. 6. ST denotes a start pulse for causing the shift register to start the operation, and CLA denotes a sampling pulse for the D-type flip-flops. As shown in the drawing, SL-R, SL-G, SL-B, and SL-X are sequentially generated at timings t1, t2, t3, and t4.

According to the circuitry having the configuration shown in FIG. 6, by continually generating (M+1) pulses whose peak values and pulse widths are identical, by supplying the first to M-th pulses to the drive circuits of the respective colors in a predetermined order, and by distributing the final pulse to the drive circuit of the color to be enhanced, i.e., by switching the supply destination of the pulses, the enhancement of a desired color becomes possible, and a display in which a specific color is enhanced is made possible with circuitry having a simple configuration. In addition, it only suffices to switch over the supply destination of the pulses, and high-speed operation is made possible.

In addition, color management of the display image can be carried out more finely by performing pulse width modulation and by changing the peak value with respect to the fourth pulse (fourth and subsequent pulses in a case where two or more pulses are further added to the number of M).

### (Configuration Which Uses Gradation Control in Combination)

Although in the above-described example a description has been given of adjustment of the light sources, if adjustment of the display image data signal is made or employed in combination, it is possible to further improve the image quality of the display image. Methods have been reported in which a gradation characteristic (tone curve or gamma) of an output image signal is changed in correspondence with an input image, but the image quality is further improved by controlling the gradation characteristic independently for each color of R, G, and B.

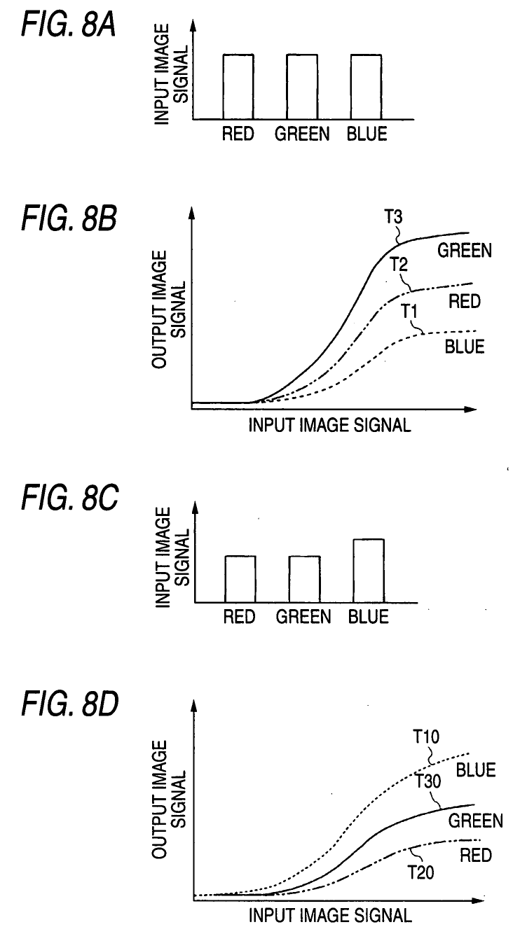

FIGS. 8A to 8D are explanatory diagrams illustrating an example in which gradation control of a display image is executed. FIG. 8A shows a case in which input image signals are at substantially the same level for the respective colors of R, G, and B, and FIG. 8B is a graph illustrating an example of gradation characteristics T1, T2, and T3 in the case of FIG. 8A. FIG. 8C shows a case in which, in the input image signals, the input signal of blue is strong among the respective colors of R, G, and B. FIG. 8D is a graph illustrating an example in which the output image level of blue in the case of FIG. 8C is enhanced, and, as for gradation characteristics T10, T20, and T30, the gradient and the luminance intensity ratio among R, G, and B are varied in response to input signals.

In a case where blue display is predominant in the input signals, the blue image can be enhanced if the maximum value of the image signal intensity of blue is set to be greater than those of green and red, and the tone curve is changed to such a one that the gradation can be expressed by being broken up finely. With respect to the other display colors as well, adjustment and enhancement of the image quality can be carried out in a similar manner. Such control is realized by such as the digital γ control circuit 206 of the image quality control circuit 200 shown in FIG. 1.

Thus, in addition to the dynamic control of the emission timing of the light sources of the respective colors, by varying the gradation characteristic (tone curve or gamma) of each color independently for each color, it is possible to attain further improvement of the image quality (improvement of the dynamic display characteristic). For example, in a case where the blue sky in the background of an input image is to be enhanced, blue is enhanced by such as the intensity adjustment of the light sources (1). Alternatively, the gradient of the gradation characteristic of blue or the intensity ratio among red, green, and blue are dynamically changed (2). Still alternatively, steps (1) and (2) are carried out simultaneously. Through such processing, it is possible to enhance, for instance, the blue sky in the image, make clear the contour and the like of the blue region, or improve the visual quality of the overall image.

Next, a description will be given of a method of optimizing the driving of light sources, which takes into account the response speed of the liquid crystal cell.

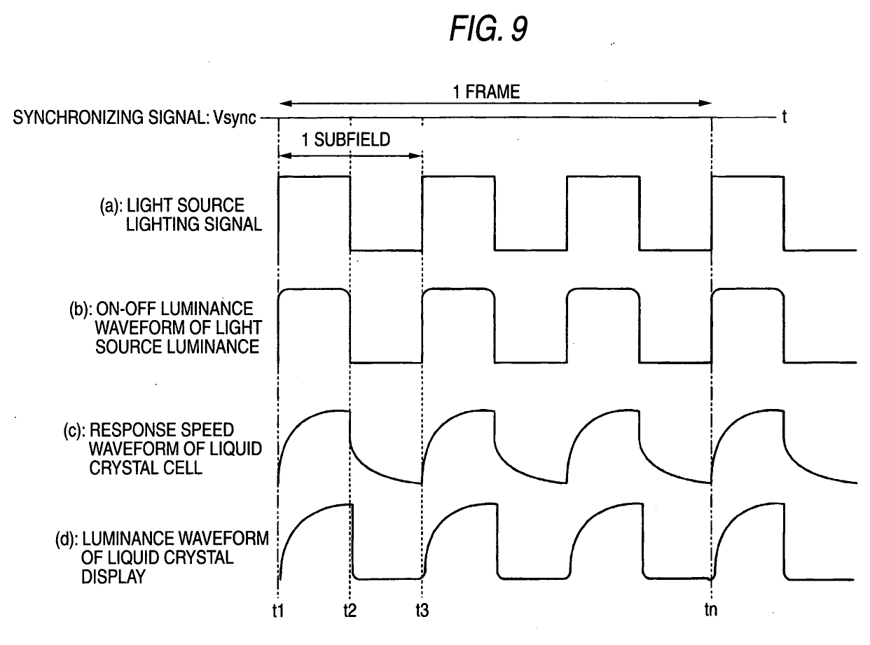

FIGS. 9A to 9D are explanatory diagrams illustrating the driving of light sources which takes into account the response speed of the liquid crystal cell.

FIG. 9A is a timing chart of a light source lighting signal, and is an example in which one frame is divided into three subfields, and the turning on and turning off of the light source is effected repeatedly in the respective subfields. FIG. 9B shows the emission luminance of the light source, and shows a luminance response waveform of the light source in which the turning on and turning off of the light is effected in synchronism with the light source lighting signal shown in FIG. 9A. In the case where the LED light source is used, the response speed of each emission at the time of the turning on and turning off of the light source is 1 ms or less, and virtually follows the light source lighting signal shown in FIG. 9A. FIG. 9C shows the response waveform of the OCB liquid crystal cell, and the alignment state is set such that the display luminance of the liquid crystal cell becomes high during a light-on period of the light source, and such that the liquid crystal cell shuts off the light during a light-off period to lower the display luminance. FIG. 9D shows a display luminance waveform of the liquid crystal display, which is shown as a result of superposition of the luminance waveform at the turning on and off of the light source and the response waveform of the liquid crystal cell. In particular, the low-luminance state of the liquid crystal cell is synchronized with the light-off period of the light source, so that a lower luminance is obtained, and the dynamic contrast increases.

To increase the dynamic contrast, it is necessary to synchronize the response waveform of the liquid crystal cell and the luminance response waveform of the light source. In the response waveform of the liquid crystal cell shown in FIG. 9C, if the response time during which the liquid crystal cell shifts from a low-luminance state to a high-luminance state lags behind the light-on period of the light source shown in FIG. 9B, the response of the liquid crystal cell does not completely catch up with the luminance response waveform of the light source, failing to lead to a high luminance. In consequence, a sufficient luminance cannot be obtained, and the dynamic contrast declines. Similarly, if the response time during which the liquid crystal cell shifts from a high-luminance state to a low-luminance state lags behind the light-off period of the light source, an adverse effect is exerted on an ensuing light-on period, and ill effects such as a residual image are produced, thereby lowering the dynamic display performance.

As described above, in the field sequential system, one frame is divided into a plurality of subfields, and light sources having a plurality of emission spectra are made to sequentially emit light in the respective subfields so as to perform color display. As the light sources and the liquid crystal cells undergo the turning-on and turning-off operation within one frame in the above-described manner, it is possible to obtain a display close to an impulse display of the CRT, further improve the moving picture display performance, and realize a smooth moving picture display.

Accordingly, that the emission turning-on time period and turning-off time period of the light source is longer than the response time at at least one of the rise and fall of the liquid crystal cell becomes effective for an excellent moving picture display. Further, the response time of the liquid crystal cell is dependent upon a birefringence value which is determined by a combination of a liquid crystal layer and an optically compensated cell, and differs for each wavelength of the light. For this reason, in a wavelength having a maximum intensity in the light source emission spectra of M kinds of color, it is effective for the emission turning-on time period and turning-off time period to be longer than the response time at at least one of the rise and fall of the liquid crystal layer.

Next, a description will be given of specific examples of the above-described configuration of the liquid crystal display in accordance with the invention. First, a description will be given of the terms and peripheral items, followed by a description of specific examples.

### (Retardations Re, Rth)

In the invention, a protective film and an optically anisotropic layer have retardations Re and Rth, and Re(λ) is measured by making light with a wavelength of λ nm incident in a direction normal to the film by using an automatic birefringence analyzer KOBRA-21ADH (manufactured by Oji Scientific Instruments Co., Ltd.). Rth(λ) is measured by KOBRA-21AH on the basis of an assumed value of a mean refractive index and an inputted film thickness value as well as retardations measured in three directions, including the aforementioned retardation Re(λ), a retardation measured by making the light with the wavelength of λ nm incident from a direction inclined by +40° to the normal direction of the film by using a slow axis in the plane (determined by KOBRA-21ADH) as an inclined axis (rotated axis), and a retardation measured by making the light with the wavelength of λ nm incident from a direction inclined by −40° to the normal direction of the film by using the slow axis in the plane as an inclined axis (rotated axis). Here, as the assumed values of the mean refractive indexes, it is possible to use the values of “POLYMER HANDBOOK” (JOHN WILEY & SONS, INC) and catalogs on various optical films. If the values of the mean refractive indexes are unknown, the values may be measured with an Abbe refractometer or the like. Values of the mean refractive indexes of major optical films are exemplified as follows: cellulose acylate (1.48), cyclo-olefin polymer (1.52), polycarbonate (1.59), polymethyl methacrylate (1.49), polystyrene (1.59). When the assumed value of the hypothetical mean refractive index and the film thickness are inputted to KOBRA-21ADH, nx, ny, and nz are calculated. NZ=(nx−nz)/(nx−ny) is further calculated from the calculated nx, ny and nz.

### (Axis of Molecular Orientation)

The axis of molecular orientation is calculated by an automatic birefringence analyzer KOBRA-21DH (manufactured by Oji Scientific Instruments Co., Ltd.) from a phase difference when after a specimen of 70 mm×100 mm is subjected to humidity conditioning at 25° C. and 65% RH for 2 hours, the angle of incidence at vertical incidence is varied.

### (Axial Offset)

The angle of axial offset can be measured by the automatic birefringence analyzer KOBRA-21ADH (manufactured by Oji Scientific Instruments Co., Ltd.). For example, 20 points can be measured at equal intervals over the entire width of the specimen in its widthwise direction, and a mean value of absolute values can be determined to be the value to be obtained. In addition, the range of the angle of the slow axis (axial offset) can be determined by measuring 20 points at equal intervals over the entire widthwise region and by taking a difference between an average of four points starting from the largest one of the absolute values of the axial offset and an average of four points starting from the smallest one of the absolute values.

### (Transmittance)

The transmittance of visible light (615 nm) can be measured for a specimen of 20 mm×70 mm at 25° C. and 60% RH with a transparency measuring instrument (AKA phototube colorimeter, manufactured by Kotaki Seisakusho Co., Ltd.)

### (Spectral Characteristics)

The transmittance at the wavelength of 300 to 450 nm is measured for a specimen of 13 mm×40 mm at 25° C. and 60% RH with a spectrophotometer (U-3210, manufactured by Hitachi, Ltd.). The gradient width is determined from a wavelength of a 72% transmittance minus a wavelength of a 5% transmittance, and the critical wavelength is expressed by a wavelength of (gradient width/2) plus 5%. The absorption edge is expressed by a wavelength of a 0.4% transmittance.

In this specification, it is assumed that, concerning the angle, “+” means a counterclockwise direction, and “−” means a clockwise direction. Also, it is assumed that when the upper direction of the liquid crystal display is set to the 12 o'clock direction and the lower direction to the 6 o'clock direction, the 0° direction of the absolute value in the angular direction means the 3 o'clock direction (the rightward direction on the screen). Further, the “slow axis” means a direction in which the refractive index becomes maximal. Further, the “visible light region” means the region of 380 nm to 780 nm. Furthermore, unless otherwise stated, the measurement wavelength is a value at λ=550 nm in the visible light region.

In addition, in cases where reference is made to the terms “parallel,” “vertical,” and “45°” with respect to the angle between axes and between directions, these terms are intended to mean “approximately parallel,” “approximately vertical,” and “approximately 45°,” and are not to be construed strictly. A slight deviation is allowed in a range in which the respective objective is attained. For example, the term “parallel” means that the angle of intersection is approximately 0°, i.e., in the range of −10° to 10°, preferably −5° to 5°, more preferably −3° to 3°. The term “vertical” means that the angle of intersection is approximately 90°, i.e., in the range of 80° to 90°, preferably 85° to 95°, more preferably 87° to 93°. The term “45°” means that the angle of intersection is approximately 45°, i.e., in the range of 35° to 55°, preferably 40° to 50°, more preferably 42° to 48°.

### (Liquid Crystal Display Panel)

In the invention, a liquid crystal display is used which is comprised of a pair of substrates at least one of which has an electrode and which are disposed in face-to-face relation; a liquid crystal layer containing liquid crystalline molecules whose orientation is controlled by the orientation axes which opposing surfaces of the pair of substrates respectively possess; a pair of polarizing plates which are disposed in such a manner as to sandwich the liquid crystal layer and which each have a polarizing film and a protective film provided at least on one surface of the polarizing film; and at least one optically anisotropic layer which contains between the liquid crystal layer and at least one of the pair of polarizing films a liquid crystalline compound whose orientation is controlled by the orientation axes and which is fixed in a state of its orientation. This liquid crystal panel has the function of selectively forming a light transmitting state and a light shielding state in correspondence with the oriented direction of the liquid crystal.

### (Basic Structure of OCB Liquid Crystal Cells)

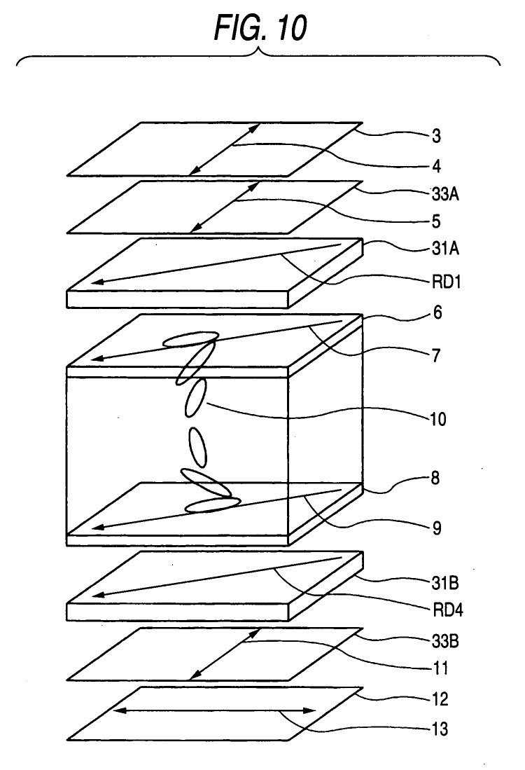

FIG. 10 shows a schematic diagram as one example of the configuration of the liquid crystal display in accordance with the invention. The liquid crystal display in the OCB mode shown in FIG. 10 has a liquid crystal cell having a liquid crystal layer 10 in which the liquid crystal is bend aligned with respect to substrate surfaces on application of a voltage, i.e., during black display, as well as a pair of substrates 6 and 8 sandwiching the liquid crystal layer 10. The substrates 6 and 8 have been subjected to alignment treatment on liquid crystal surfaces thereof, and their rubbing directions are indicated by arrows 7 and 9. Polarizing films 3 and 12 are disposed in such a manner as to sandwich the liquid crystal cell. The polarizing films 3 and 12 are disposed with their respective absorption axes 4 and 13 set perpendicular to each other and at angles of 45 degrees to the rubbing directions 7 and 9 of the liquid crystal layer 10 of the liquid crystal cell. Protective films 33A and 33B and optically anisotropic layers 31A and 31B are respectively disposed between each of the polarizing films 3 and 12 and the liquid crystal cell. The protective films 33A and 33B are disposed with their slow axes 5 and 11 set perpendicular to the directions of the absorption axes 4 and 13 of the polarizing films 3 and 13 which are respectively adjacent thereto. In addition, the optically anisotropic layers 31A and 31B have optical anisotropy which appears depending on the orientation of the liquid crystal compound.

The liquid crystal cell shown in FIG. 10 is comprised of the upper substrate 6, the lower substrate 8, and a liquid crystal layer constituted by the liquid crystal layer 10 sandwiched therebetween. An alignment layer (not shown) is formed on the surface (referred to as the “inner surface” in some cases) of each of the substrates 6 and 8 which is in contact with the liquid crystal layer 10, and the orientation of the liquid crystal layer 10 in a voltage non-applied state or a low-voltage applied state is controlled to a parallel direction having a pretilt angle. Further, a transparent electrode (not shown) capable of applying a voltage to the liquid crystal layer constituted by the liquid crystal layer 10 is formed on the inner surface of each of the substrates 6 and 8. In the invention, the product Δn·d of a liquid crystal layer thickness d (μm) and a refractive index anisotropy Δn is preferably set to 0.1 to 1.5 μm, more preferably 0.2 to 1.5 μm, much more preferably 0.2 to 1.2 μm, and even more preferably 0.6 to 0.9 μm. In these ranges, since the white display luminance is high at the time of application of a voltage for white, a display which is bright and has a high contrast can be obtained. Although the liquid crystal material used is not particularly limited, a liquid crystal material is used whose dielectric anisotropy is positive such that the liquid crystal layer 10 responds parallel to the direction of the electric field in a mode in which an electric field is applied across the upper and lower substrates 6 and 8.

For example, in a case where the liquid crystal cell is a liquid crystal cell of the OCB mode, it is possible to use between the upper and lower substrates 6 and 8 such as a nematic liquid crystal material whose dielectric anisotropy is positive, Δn=0.08, and Δε=5 or thereabouts. Although the thickness d of the liquid crystal layer is not particularly limited, in the case where the liquid crystal having the properties of the aforementioned ranges is used, it is possible to set the thickness d to 6 μm or thereabouts. Since the brightness during white display changes due to the magnitude of the product Δn·d of the thickness d and the refractive index anisotropy Δn at the time of application of the voltage for white, in order to obtain sufficient brightness at the time of application of the voltage for white, the product Δn·d of the liquid crystal layer in the non-applied state is preferably set in the range of 0.6 to 1.5 μm.

It should be noted that, the addition of a chiral material, which is generally employed in a TN mode liquid crystal display, is less frequently employed in the liquid crystal display in the OCB mode since it deteriorates the dynamic response characteristic, but a chiral material may be added for the reduction of faulty alignment. In addition, in a case where a multi-domain structure is adopted, the addition of the chiral material is advantageous in adjusting the orientation of liquid crystal molecules in boundary regions between the domains. The multi-domain structure refers to a structure in which one pixel of the liquid crystal display is divided into a plurality of regions. For instance, if the multi-domain structure is adopted in the OCB mode, the viewing angle characteristics of luminance and color tone can be favorably improved. Specifically, as each of the pixels is averaged by being formed by two or more (preferably 4 or 8) regions where initial alignment states of the liquid crystal molecules are mutually different, it is possible to reduce the bias of the luminance and color tone which are dependent on the viewing angle. In addition, similar advantages are obtained if the respective pixels are formed by two or more mutually different regions where alignment directions of the liquid crystal molecules in the voltage applied state change continually.

The protective films 33A and 33B satisfy the relationship that a ratio Re/Rth (450 nm) between Re and Rth at a wavelength of 450 nm is 0.4 to 0.95 times Re/Rth (550 nm) at a wavelength of 550 nm, and that Re/Rth (650 nm) at a wavelength of 650 nm is 1.05 to 1.9 times Re/Rth (550 nm), and Rth is 70 to 400 nm. The protective films 33A and 33B may function as supports for the optically anisotropic layers 31A and 31B, or may function as protective films for the polarizing films 3 and 12, or may have both of these functions. Namely, the polarizing film 3, the protective film 33A, and the optically anisotropic layer 31A or the polarizing film 12, the protective film 33B, and the optically anisotropic layer 31B may be incorporated in the liquid crystal display as an integrated laminate, or may be incorporated as respectively independent members.

The absorption axes 4 and 13 of the polarizing films 3 and 12, the slow axis directions 5 and 11 of the protective films 33A and 33B, and the alignment direction of the liquid crystal layer 10 are adjusted in optimal ranges in correspondence with the materials used for the respective members, the display mode, the laminating structure of the members, and the like. Namely, these members are disposed such that the absorption axis of the polarizing film 3 and the absorption axis of the polarizing film 12 are substantially perpendicular to each other. However, the liquid crystal display in accordance with the invention is not limited to this configuration.

Each of the optically anisotropic layers 31A and 31B is disposed between the respective one of the protective films 33A and 33B and the liquid crystal cell. The optically anisotropic layers 31A and 31B are layers which are formed of a composition containing a liquid crystalline compound, e.g., a rod-like compound or a discotic compound. In the optically anisotropic layer, the molecules of the liquid crystalline compound are fixed in a predetermined alignment state. The slow axes 5 and 11 in the planes of the protective films 33A and 33B, on the one hand, and average directions of orientation, RD1 and RD4, at least at the interfaces on the sides of the protective films 33A and 33B, of molecular symmetrical axes of the liquid crystalline compounds in the optically anisotropic layers 31A and 31B, on the other hand, intersect each other at approximately 45 degrees. If the optically anisotropic layers 31A and 31B and the protective films 33A and 33B are disposed in the above-described relationship, the optically anisotropic layers 31A and 31b produce retardations with respect to the incident light from the normal direction, so that light leakage is not generated, and the effect of the invention can be sufficiently demonstrated with respect to the incident light from diagonal directions. At the interface on the liquid crystal cell side as well, the average directions of orientation of the molecular symmetrical axes of the optically anisotropic layers 31A and 31B are preferably at approximately 45 degrees to the slow axes 5 and 11 in the planes of the protective films 33A and 33B.

Here, a more detailed description will be given of the liquid crystal display shown in FIG. 10.

In this liquid crystal display, the bent alignment liquid crystal cell (10) is optically compensated through cooperation between optically anisotropic layers (31A, 31B) formed from a discotic compound and transparent supports (33A, 33B) having optical anisotropy.

If the rubbing directions (RD1, RD4) for aligning the discotic compound in the optically anisotropic layers (31A, 31B) are set in an anti-parallel relation to the rubbing directions (7, 9) of the liquid crystal cell, the liquid crystal molecules of the bend alignment liquid crystal (10) and the discotic compound of the optically anisotropic layers (31A, 31B) correspond and optically compensate. Further, it has been so designed that the optical anisotropy of the transparent supports (33A, 33B) corresponds to the liquid crystal molecules which are substantially vertically oriented in the central portion of the bend alignment liquid crystal (10). It should be noted that ellipses depicted in the liquid crystal cell are refractive index ellipses which are generated due to the optical anisotropy of the transparent supports. Thus, as optical characteristics of the optically anisotropic layers and transparent supports of optical compensatory sheets are adjusted in correspondence with the orientation of the liquid crystal in the black display state of the liquid crystal cell, the optical anisotropy of the liquid crystal cell can be compensated to a high degree, and a wide viewing angle can be realized.

The rubbing direction (7, 9) of the liquid crystal cell may be an arbitrary direction in the plane of the screen, but should preferably be a lateral direction, a lengthwise direction, a 45-degree direction, or a 135-degree direction in the plane of the screen.

If two polarizing films are arranged in a crossed Nicols configuration, the transmittance as viewed from direction normal to the polarizing film is very low, but if the viewing angle is tilted from the normal direction toward the direction of a median line between the transmission axes of the two polarizing films, the transmittance become large. This is because, as described in SID '98 Digest, p. 315, the tilting of the viewing angle causes the angle formed by the transmission axes of the incident-side polarizing film and the emission-side polarizing film to be offset from the crossed Nicols configuration (90°). The light leakage at the time when this viewing angle is tilted can be substantially reduced by a combination of a positive A-plate and a positive C-plate, a combination of a negative A-plate and a negative C-plate, or the use of a biaxial film. Here, in the case of the combination of the A-plate and the C-plate, the optical axis of the A-plate is disposed parallel to the transmission axis of the polarizing film, and in the case of the biaxial film, the slow axis is disposed parallel to the transmission axis of the polarizing film.

In the optical compensatory sheet used in the invention, by adjusting the Re retardation value and the Rth retardation value of the transparent supports, it is possible to realize not only the function of compensating the optical anisotropy of the liquid crystal cell but also the function of the above-described wide viewing angle polarizing plates.

### (Hue in Black Display)

In a case where the wavelength dispersion of the optically anisotropic layer of the optically anisotropic layer of the optically compensatory sheet and the wavelength dispersion of the liquid crystal used in the cell agree with each other, the hue in the normal direction in black display is neutral. However, in a case where the wavelength dispersions of the optically anisotropic layer and the liquid crystal cell differ, the transmittances of R, G, and B pixels differ, so that the hue is offset from neutral and coloration occurs. Accordingly, it is possible to render the hue of black display neutral through the following means (1) or (2).
(1) A voltage at each of R, G, and B pixels is adjusted to minimize the transmittance of each of R, G, and B pixels.
(2) A cell gap at each of R, G, and B pixels is adjusted to minimize the transmittance of each of R, G, and B pixels.

In the state of black display, a u0 value (the value of uv chromaticity measured in the normal direction of the liquid crystal display) is preferably 0.17 or more. The adjustment of the u0 value is particularly effective when a wavelength dispersion value α1 of the optically anisotropic layer to be described later is 1.0 to 1.4. In the state of black display, it is also preferable that a v0 value is 0.18 or more. The adjustment of the u0 value is particularly effective when the wavelength dispersion value α1 of the optically anisotropic layers to be described later is 1.4 to 2.0.

### (Wavelength Dispersion Value)

In the liquid crystal display in accordance with the invention, it is desirable that the optically anisotropic layer and transparent support of the optical compensatory sheet have certain wavelength dispersion values.

A value α1 representing the wavelength dispersion value of the optically anisotropic layer defined by Formula (III) below is preferably 1.0 to 2.0, more preferably 1.1 to 1.9, and most preferably 1.2 to 1.8.

Δ=Re(400 nm)/Re(550 nm) (III)

In Formula (III) above, α represents a wavelength dispersion value; Re (400 nm) represents a retardation value measured on light having a wavelength of 400 nm; and Re (550 nm) represents a retardation value measured on light having a wavelength of 550 mn.

A value α2 representing the wavelength dispersion value of the transparent support which is defined by Formula III above preferably satisfies Formula (IV) below, more preferably satisfies Formula (IV-2) below, and most more preferably satisfies Formula (IV-3) below.

(1.4−0.5α1<α2<(2.3−0.5α1) (IV)

(1.5−0.5α1<α2<(2.2−0.5α1) (IV-2)

(1.6−0.5α1<α2<(2.1−0.5α1) (IV-3)

### (Support)

The transparent support of the optically compensatory sheet comprises at least one polymer film. The optical isotropy which is defined in the invention can also be realized by forming the transparent support by a plurality of polymer films. However, the optical isotropy which is defined in the invention can be realized by a single polymer film. Accordingly, it is particularly preferable for the transparent support to comprise a single polymer film. Specifically, the optical isotropy of the transparent support means that the transparent support has in the range of 10 to 70 nm an Re retardation value measured with the light having a wavelength of 632.8 nm, and has in the range of 50 to 400 nm an Rth retardation value measured with the light having a wavelength of 632.8 nm. It should be noted that in a case where two optically isotropic polymer films are used in the liquid crystal display, the Rth retardation value of one film is preferably 50 to 200 nm. In a case where one optically isotropic polymer film is used in the liquid crystal display, the Rth retardation value of the film is preferably 70 to 400 nm.

An average value of the slow axis angle of the polymer film is preferably 3° or less, more preferably 2° or less, and most preferably 1° or less. The direction of the average value of the slow axis angle is defined as the average direction of the slow axis. Further, a standard deviation of the slow axis angle is preferably 1.5° or less, more preferably 0.8°, and most preferably 0.4° or less. The angle of the slow axis within the plane of the polymer film is defined by an angle formed by the slow axis and a reference line (0°) by using the stretching direction of the polymer film as the reference line. When a film in roll form is stretched in the widthwise direction, the widthwise direction is set as the reference line, and when it is stretched in the lengthwise direction, the lengthwise direction is set as the reference line.

The polymer film preferably has a light transmittance of 80% or more. The polymer film preferably has a photoelastic coefficient of 60×10⁻¹²m²/N or less.

In a transmissive liquid crystal display employing an optical compensatory sheet, “frame-like display unevenness” may be observed in a peripheral part of the screen with the lapse of time after energization. This unevenness is attributable to an increase in transmittance at the peripheral part of the screen and is noticeable especially at the time of black display. In the transmissive liquid crystal display, heat is generated from the light sources, and a temperature distribution occurs in the plane of the liquid crystal cell. Variations of optical characteristics (retardation values and the angle of the slow axis) of the optical compensatory sheet attributable to this temperature distribution are causes of the “frame-like display unevenness.” The variations in the optical characteristics of the optical compensatory sheet are caused by elastic deformation of the optical compensatory sheet which is attributable to the fact that expansion or contraction of the optical compensatory sheet resulting from a temperature rise is suppressed by its adhesion to the liquid crystal cell or the polarizing plate.

In order to reduce the “frame-like display unevenness” generated in the transmissive liquid crystal display, a polymer film having a high thermal conductivity is preferably used as the transparent support of the optical compensatory sheet. Examples of the polymer having a high thermal conductivity include cellulose type polymers such as cellulose acetate (thermal conductivity: 0.22 W/(m·K)), polyester type polymers such as polycarbonate (0.19 W/(m·K)), and cyclic olefin polymers such as norbomene type polymers (0.20 W/(m·K)).

### (Alignment Layer)

In the invention, the orientation of the liquid crystalline compound in the optical anisotropic layer is controlled by the orientation axis and is fixed in that state. As the orientation axis for controlling the alignment of the aforementioned liquid crystalline compound, it is possible to cite the rubbing axis of the alignment layer formed between the optical anisotropic layer and the aforementioned polymer film (support). In the invention, however, the alignment layer is not limited to the rubbing axis, and any orientation axis may be used insofar as it is capable of controlling the orientation of the liquid crystalline compound in the same way as the rubbing axis.

The alignment layer has the function of restricting the orientation of the liquid crystalline molecules. Accordingly, the alignment layer is essential in realizing the preferred mode of the invention. This being the case, however, if the liquid crystalline compound, after being aligned, has its alignment state fixed, the alignment layer accomplishes its function, so that the alignment layer is not necessarily essential as a constituent element of the invention. Namely, it is also possible to fabricate the polarizing plate of the invention by transferring onto the polarizer only the optically anisotropic layer on the alignment layer with its alignment state fixed.

The alignment layer can be basically formed by coating the transparent support with a coating liquid containing the aforementioned polymer, i.e., an alignment layer forming material, and a crosslinking agent, drying on heating (crosslinking) the polymer, and subjecting the formed layer to rubbing treatment.

The alignment layer is provided on the transparent support or the aforementioned undercoating layer. The alignment layer can be obtained by crosslinking the polymer layer in the above-described manner and by subsequently subjecting the surface of the layer to rubbing treatment.

### (Optically Anisotropic Layer)

Next, a detailed description will be given of a preferred form of the optically anisotropic layer constituted of a liquid crystalline compound. The optically anisotropic layer is preferably designed so as to compensate the liquid crystal compound in the liquid crystal cell in the black display of the liquid crystal display. The state of orientation of the liquid crystal compound in the liquid crystal cell in the black display differs depending on the mode of the liquid crystal display. The state of alignment of the liquid crystal compound in the liquid crystal cell is described in IDW '00 FMC 7-2, pp. 411 to 414. The optically anisotropic layer contains a liquid crystalline compound whose orientation is controlled by the orientation axis such as a rubbing axis and which is fixed to its oriented state.

Examples of liquid crystalline molecules used in the optically anisotropic layer include rod-like liquid crystalline molecules and discotic liquid crystalline molecules. The rod-like liquid crystalline molecules and the discotic liquid crystalline molecules may be those of a high molecular weight liquid crystal or a low molecular weight liquid crystal, and further include those in which a low molecular weight liquid crystal has been crosslinked and ceased to exhibit liquid crystallinity. In a case where a discotic liquid crystalline compound is used in the fabrication of the optically anisotropic layer, the discotic liquid crystalline molecule is preferably such that an average direction of the axis in which its short axis is projected onto the support plane is parallel to the alignment axis. In addition, the hybrid alignment is preferable in which the angle (tilt angle) between the disc plane and the layer plane changes in the depthwise direction.

The thickness of the optically anisotropic layer is preferably 0.1 to 20 μm, more preferably 0.5 to 15 μm, most preferably 1 to 10 μm.

### (Elliptically Polarizing Plate)

In the invention, it is possible to use an elliptically polarizing plate in which the above-described optically anisotropic layer and a linearly polarizing film are integrated. The elliptically polarizing plate is preferably molded in a substantially identical shape to the pair of substrates constituting the liquid crystal cell (e.g., if the liquid crystal cell is rectangular, the elliptically polarizing plate is also preferably molded in an identical rectangular shape). In the invention, the alignment axes of the substrates of the liquid crystal cell and the absorption axis of the linearly polarizing film and/or the alignment axes of the optically anisotropic layers are adjusted at specific angles.

The aforementioned elliptically polarizing plate can be fabricated by laminating the aforementioned optically compensatory sheet and the linearly polarizing film (hereafter, in cases where reference is made to the “polarizing film,” it is meant to refer to the “linearly polarizing film”). The optically compensatory sheet may also serve as a protective film for the linearly polarizing film.

As the linearly polarizing film, a coating-type polarizing film typified by Optiva Inc., or a polarizing film comprising a binder and iodine or a dichroic dye is preferable. The polarization performance develops as alignment takes place in iodine or the dichroic dye in the linearly polarizing film. Preferably, iodine or the dichroic dye is aligned along binder molecules, or the dichroic dye is aligned in a single direction due to its self-organization as in a liquid crystal. At present, commercially available polarizers are generally fabricated by immersing a stretched polymer in a solution of iodine or a dichroic dye in a bath, and by allowing iodine or the dichroic dye to permeate the binder.

A polymer film is preferably disposed on the surface of the linearly polarizing film opposite to the optically anisotropic layer (the arrangement being in the order of the optically anisotropic layer, the polarizing film, and the polymer film).

The polymer film is also preferably such that its outermost surface is provided with an anti-reflection film having an antifouling property and abrasion resistance. As the anti-reflection film, it is possible to use any conventionally known one.

The liquid crystal cell performs display by changing the alignment state of the liquid crystal through an electric field, and the liquid crystal cells can be classified into display modes on the basis of the difference in the state of orientation in a voltage non-applied state. These display modes include the following: a vertically aligned (VA) mode in which liquid crystal molecules assume an initial alignment perpendicular to the substrate; a homogeneously aligned electrically controlled birefringence (ECB) mode in which liquid crystal molecules assume an initial alignment parallel to the substrate; a hybrid aligned nematic (HAN) mode in which one side is homeotropically aligned and the other side is homogeneously aligned; an optically compensatory bend (OCB) mode or a bend mode in which liquid crystal molecules are homogeneously aligned in the vicinity of the substrate, but is homeotropically aligned in an intermediate layer between the substrates; a twisted nematic (NT) mode in which liquid crystal molecules are aligned parallel to the substrate, but its alignment direction is different between the upper and lower substrates and has a twisted structure; a super twisted nematic (STN) mode in which although the twist angle of the ordinary TN mode is in the range of 0 to 100 degrees, liquid crystal molecules are twisted by 180 to 270 degrees; and a cholesteric liquid crystal mode in which liquid crystal molecules have a 270° twisted structure. Other display modes include an in-plane switching (IPS) mode in which liquid crystal molecules are aligned parallel to the substrate, and the orientation of the liquid crystal changes in the substrate plane due to a so-called transverse electric field parallel to the substrate plane; and a ferroelectric liquid crystal (FLC) mode in which the display is switched by a change in the in-plane orientation direction as with the IPS mode by means of an electric field perpendicular to the substrate plane.

The characteristics of the respective display modes are as follows: The VA mode has a fast on-off response speed between black and white, and the alignment treatment in the rubbing process can be omitted. The respective modes of IPS and FLC have wide viewing angles. In the OCB mode, the response speed is fast in the display at all gradation levels. FLC and the cholesteric liquid crystal mode are capable of imparting a memory feature, and are effective in low power consumption. The TN mode has a high transmission, and the fabrication process is simple.

Incidentally, although one form of the liquid crystal display in the OCB mode is shown in FIG. 10, the liquid crystal display in accordance with the invention may employ any one of the TN mode, the VA mode, the bend mode, the OCB mode, the ECB mode, and the FLC mode. The OCB is preferable especially from the viewpoint of high response characteristics. Further, in the liquid crystal display of each display mode, if the so-called multi-domain structure in which one pixel is divided into a plurality of regions is adopted, vertical and horizontal viewing angle characteristics can be averaged, and the display quality improves.

In addition, the liquid crystal display in accordance with the invention is not limited to the configuration shown in FIG. 10, and may comprise other members. For example, the liquid crystal display in accordance with the invention may be a reflection type liquid crystal display. In that case, it suffices to use only one polarizing plate disposed on the viewing side, and a reflection film is installed on the rear surface of the liquid crystal cell or on the inner surface of the lower substrate of the liquid crystal cell. It goes without saying that a front light using the light source can also be provided on the liquid crystal cell on the viewing side. Further, to make the transmission and reflection modes compatible, the liquid crystal display in accordance with the invention may be configured by a semi-transmitting type in which a reflection part and a transmission part are provided in one pixel.

Further, to enhance the light emission efficiency of the light sources, it is possible to laminate a prism-like or lens-like focusing-type luminance improvement sheet (film), or laminate between the light sources and the liquid crystal cell a polarization/reflection type luminance improvement sheet (film). Further, it is also possible to laminate a diffusion sheet (film) for making the light sources of the backlight uniform, and laminate a sheet (film) with a diffusion pattern formed thereon by printing or the like.

In addition, the liquid crystal display in accordance with the invention includes a direct image viewing type, an image projection type, and an optical modulation type. A form in which the invention is applied to an active matrix liquid crystal display using a three-terminal or two-terminal semiconductor device such as TFT and a metal-insulator-metal (MIM) liquid crystal is particularly effective. It goes without saying that a form in which the invention is applied to a passive matrix liquid crystal display typified by the STN type which is called time-division drive is also effective.

As for the light sources of the field sequential system, it is possible to use cold-cathode tubes and LEDs used in the backlights of the background art. As for the cold-cathode tubes, to obtain flickerless white light, cold-cathode tubes having a long afterglow time have hitherto been required. However, for the purpose of high-speed drive capable of sufficiently coping with excellent moving picture performance in the field sequential system, cold-cathode tubes having a short afterglow time are instead effective.

Since the LED light sources are dc driven, if light sources comprising only LEDs are used, since an inverter circuit is not required, this arrangement is effective in making the apparatus compact and lightweight and in heat prevention. In addition, the LEDs are able to attain a long emission life, and are therefore effective in improvement of reliability.

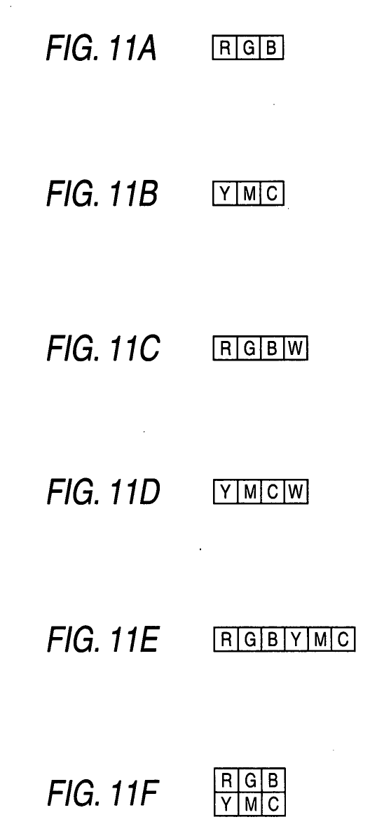

FIGS. 11A to 11F are diagrams respectively illustrating examples of the layout of LEDs in the case where the LEDs are used as the backlight sources.

In the liquid crystal display in accordance with the invention, a backlight which is shown in FIG. 11A and constituted by RGB three-color LED light sources, or a backlight which is shown in FIG. 11B and constituted by three-color LED light sources of Y (yellow), M (magenta, and C (cyan), which are complementary colors of R, G, and B, are effective. Further, combinations of R, G, B, and W in FIG. 11C and Y, M, C, and W in FIG. 11D, in which a white light source (W) is further added, are also conceivable for improvement of the luminance of the backlight. In addition, combinations of R, G, B, Y, M, and C shown in FIGS. 11E and 11F are also effective from the viewpoint of enlargement of the reproducible color gamut.

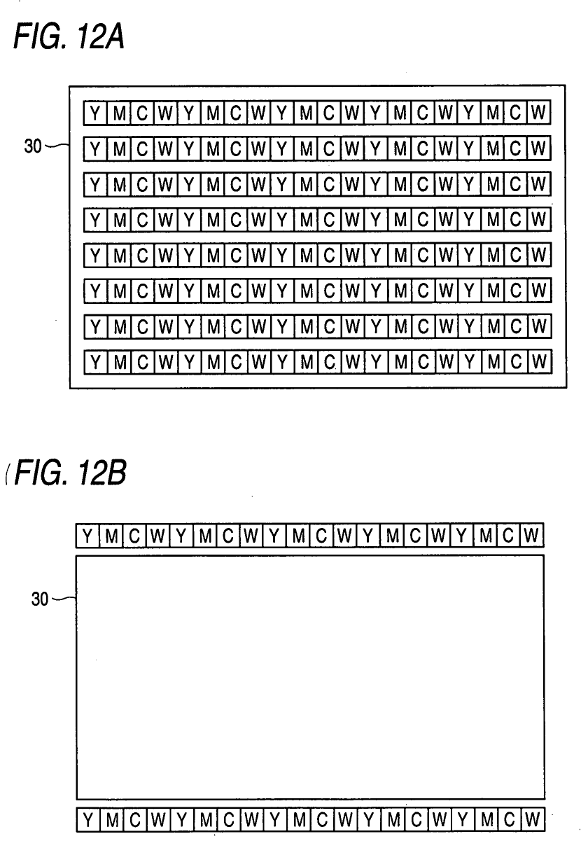

FIGS. 12A and 12B are diagrams illustrating examples of the configuration of the backlight. FIG. 12A is a diagram illustrating the configuration of the directly-below type, and FIG. 12B is a diagram illustrating the configuration of a side edge type. In terms of the layout of the light sources, it is possible to use horizontal single-row layouts as shown in FIGS. 11A to 11E, a box layout shown in FIG. 11F, a delta layout, and the like. As a backlight configuration using the horizontal single-row layout, a directly-below type shown in FIG. 12A and a side edge type shown in FIG. 12B are conceivable. The directly-below type is capable of smooth moving picture display, and the side edge type is effective in realizing a compact size and low power consumption of the backlight.

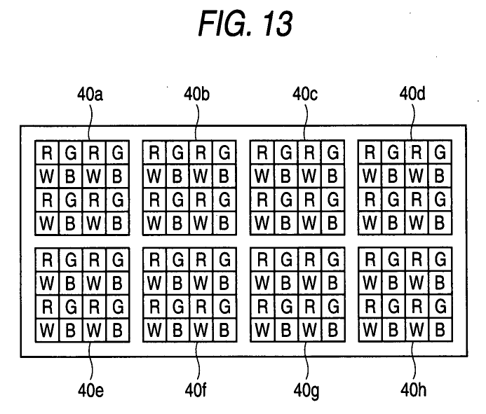

FIG. 13 is a diagram illustrating the configuration of a backlight using light sources arranged in box-shapes. As a group of LEDs 40a to 40h arranged in box shapes immediately below the liquid crystal panel, as shown in the drawing, it is also possible to brightly enhance portions of the screen.

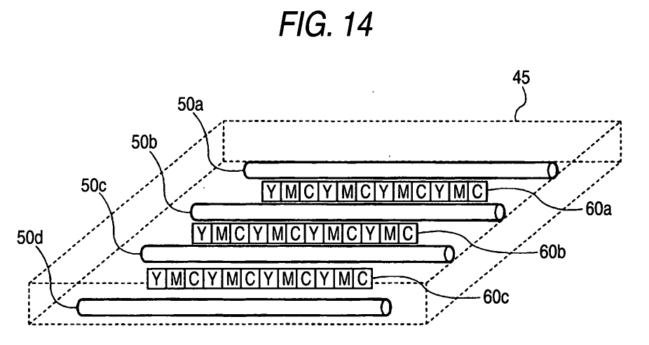

FIG. 14 is a diagram illustrating the configuration of a backlight in which cold-cathode tubes and LEDs are combined. The combination of the cold-cathode tubes and the LEDs (or a combination of the LEDs of RGB and YMC) is also effective in the enlargement of the reproducible gamut of display colors.

### (Enlargement of Reproducible Color Gamut)

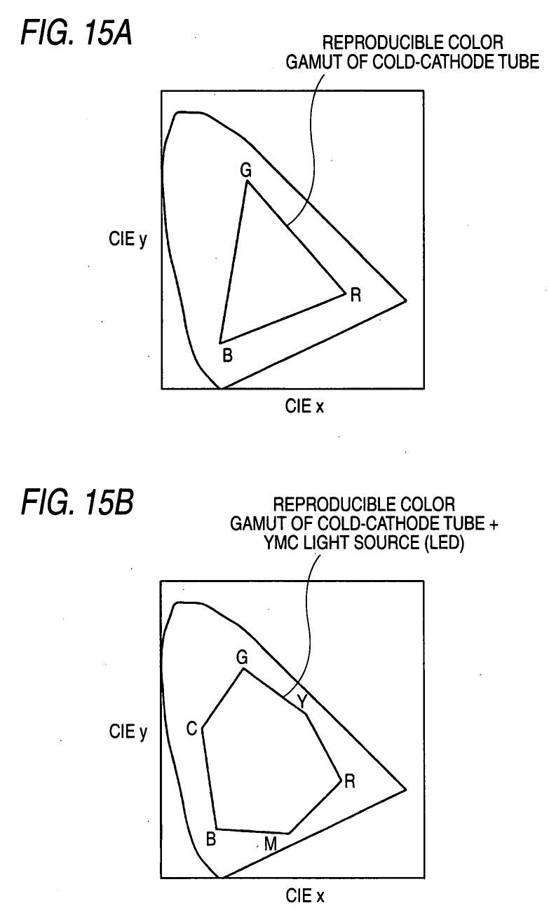

In liquid crystal displays of the background art, the reproducible gamut of display colors has been determined by the combination of the emission spectrum of the backlight constituted by cold-cathode tubes and a transmitted light spectrum of color filters. FIGS. 15A and 15B are diagrams illustrating examples of a reproducible color gamut in the CIE color system (color space), in which FIG. 15A is a diagram illustrating a reproducible color gamut of a liquid crystal display using cold-cathode tubes, and FIG. 15B is a diagram illustrating a reproducible color gamut of a liquid crystal display using the combination of cold-cathode tubes and LEDs which are YMC light sources.

In FIG. 15A, the cold-cathode tube is a white light with three wavelengths. Although it is possible to fabricate monochromatic fluorescent lamps of R, G, and B, the LED light sources are preferable in consideration of the response speed of lighting. Alternatively, a combination with the LED light sources is preferable. As for the LED light sources, the emission spectrum of each color of R, G, and B is sharp, and its reproducible color gamut is wider than that of a color filter. The reproducible color gamut shown in FIG. 15B in the combination of the cold-cathode tubes and the LEDs of the YMC light sources is wider than that shown in FIG. 15A.

### EXAMPLE 1

A more specific description will be given of the invention by citing examples.

### (Fabrication of Liquid Crystal Display)

Two elliptically polarizing plates were adhered in such a manner as to sandwich the bent alignment cell. The transmission axis of one polarizing plate was disposed at 90° in the plane of the screen, while the transmission axis of the other polarizing plate was disposed at 0° in the plane of the screen.

The arrangement provided was such that the optically anisotropic layer of the elliptically polarizing plate opposed the cell substrate, and the rubbing direction of the liquid crystal cell and the rubbing direction of the optically anisotropic layer opposing the same were anti-parallel.

The liquid crystal display thus fabricated was disposed on a field sequential backlight constituted by four colors of LED light sources, a white display voltage of 2 V was applied to the liquid crystal cell, and color coordinates in the normal direction of the panel were measured using a luminance meter (BM-5A manufactured by TOPCON CORPORATION). As for the reproducible color gamut, a NTSC ratio of 90% was obtained in contrast to the fact that a conventional commercially available color liquid crystal display combining a cold-cathode tube backlight and color filters (e.g., EIZO-FORIS Type 23, manufactured by EIZO NANAO CORPORATION) has an NTSC ratio of 70%. Here, the LED backlight was configured for one frame at 60 Hz, one frame was divided into four subfields, and voltage control was provided for the LEDs by an arbitrary-waveform generating device so as to light up 80% of one subfield period. R, G, and B were sequentially lit in the respective subfields in one frame, and white LEDs were lit up in an ensuing subfield. As a result, a white luminance of 120 cd/m² was obtained.

In addition, a black display voltage of 6 V was applied, and when the contrast ratio (CR) was measured, 1200:1 was obtained.

### EXAMPLE 2

The lighting of the W light sources in the final subfield was not effected at the time of black display in Example 1 (variable gradation). The reproducible range of color at this time was the same, but the contrast ratio was 200:1.

### EXAMPLE 3

The arrangement adopted was such that the LEDs of the B light sources were lit up in the final subfield in Example 1. When white and black display was effected, the light sources of the three colors of R, G, and B were lit up. When blue display was effected, the blue LEDs were lit up in the final subfield. The blue contrast ratio (blue CR) calculated from the ratio between the blue display luminance and the black display luminance improved from 700:1 to 1200:1.

### EXAMPLE 4

Six colors were used for the LEDs of the light sources by further adding Y, M, and C to R, G, and B, and the other arrangements were the same as those of Example 1. One frame was set to 16.7 ms (60 Hz) and was divided into six subfields, one subfield being set to 2.783 ms. The respective light sources were blinked by setting a ratio of turn-on and turn-off periods to 1 to 1. In addition, a voltage of 2 V for constantly setting a state of high transmittance was applied to the liquid crystal cell and was held in that state. As a result, as the reproducible color gamut, an NTSC ratio of 120% was obtained. This corresponds to an enlargement of the reproducible color gamut from FIG. 15A to 15B. As the contrast ratio, 1500:1 was obtained due to an increase in the white luminance.

The results of the optical performance of the above-described Examples are shown in Table 1.

TABLE 1

| | | | | | | | | | DISPLAY PERFORMANCE | | | |
|---|---|---|---|---|---|---|---|---|---|---|---|---|
| | BACKLIGHT SOURCE COLOR | | | | | | | GRADATION | WHITE LUMINANCE | | BLUE | COLOR |
| | R | G | B | W | Y | M | C | VARIABLE | (cd/m²) | CR | CR | REPRODUCIBILITY |
| Example 1 | ◯ | ◯ | ◯ | ◯ | — | — | — | — | 120 | 1200 | 700 | 90% |
| Example 2 | ◯ | ◯ | ◯ | ◯ | — | — | — | ◯ | 120 | 2000 | 1000 | 90% |
| Example 3 | ◯ | ◯ | ◯◯ | — | — | — | — | — | 100 | 1000 | 1200 | 90% |
| Example 4 | ◯ | ◯ | ◯ | — | ◯ | ◯ | ◯ | — | 150 | 1500 | 800 | 120% |

As described above, according to the invention, the emission intensity or the emission period of each light source in each of the subfields, or the number of emission times of each light source during a one-frame period, is dynamically changed, or the conditions of various parts of the liquid crystal display are optimized, thereby making it possible to obtain advantages in improving the image quality of the sequential type liquid crystal display. Accordingly, the invention is useful as a liquid crystal display which excels in the moving picture performance and having wide viewing angle characteristics and wide color reproducibility.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2006-079288 filed Mar. 22 of 2006, the contents of which are incorporated herein by reference.

What is claimed is:

1. A liquid crystal display comprising:
a liquid crystal panel containing a liquid crystal, the liquid crystal panel selectively forming one of a light transmitting state and a light shielding state in correspondence with an alignment direction of the liquid crystal;
light sources of M kinds of different colors, M being a natural number of 3 or more, each of the light sources illuminating light onto the liquid crystal panel; and
a light source driving unit that drives sequentially the light sources in a time-sharing mode in correspondence with M or more subfields into which a one-frame period of an input image signal is divided,
wherein the light source driving unit changes, in correspondence with the input image signal, at least one of: an emission intensity in a subfield of the M or more subfields; an emission period in the subfield; and the number of emission times during the one-frame period with respect to a light source, so as to change a maximum luminance of at least one specific color corresponding to the light source in the subfield.

2. A liquid crystal display comprising:
a liquid crystal panel containing a liquid crystal, the liquid crystal panel selectively forming one of a light transmitting state and a light shielding state in correspondence with an alignment direction of the liquid crystal;
light sources of M kinds of different colors, M being a natural number of 3 or more, each of the light sources illuminating light onto the liquid crystal panel from a side opposite to a display side of the liquid crystal panel;
a light source driving unit that drives sequentially the light sources in a time-sharing mode in correspondence with M or more subfields into which a one-frame period of an input image signal is divided; and
a liquid crystal driving unit that drives the liquid crystal panel,
wherein the liquid crystal driving unit changes a gradation characteristic independently with respect to each of the light sources, the gradation characteristic representing a relationship between an emission intensity of each of the light sources with respect to the input image signal, so as to change a maximum luminance of at least one specific color in a subfield of the M or more subfield.

3. A liquid crystal display comprising:
a liquid crystal panel containing a liquid crystal, the liquid crystal panel selectively forming one of a light transmitting state and a light shielding state in correspondence with an alignment direction of the liquid crystal;
light sources of M kinds of different colors, M being a natural number of 3 or more, each of the light sources illuminating light onto the liquid crystal panel;
a light source driving unit that drives sequentially the light sources in a time-sharing mode in correspondence with M or more subfields into which a one-frame period of an input image signal is divided; and
a liquid crystal driving unit that drives the liquid crystal panel,
wherein the light source driving unit changes, in correspondence with the input image signal, at least one of: an emission intensity in a subfield of the M or more subfields; an emission period in the subfield; and the number of emission times during the one-frame period with respect to a light source, and the liquid crystal driving unit changes a gradation characteristic independently with respect to each of the light sources, the gradation characteristic representing a relationship between an emission intensity of each of the light sources with respect to the input image signal, so as to change a maximum luminance of at least one specific color corresponding to the light source in the subfield.

4. The liquid crystal display of claim 1, further comprising a number-of-emission controlling unit that: divides the one-frame period into (M+n) subfields, n being a positive integer; allots an emission by each of the light sources once in the one-frame period; and additionally allots an emission by the light source corresponding to the specific color in the one-frame period, so as to dynamically change the number of emissions with respect to each of the light sources during the one-frame period,

5. The liquid crystal display of claim 4, wherein the light source driving unit comprises drive circuits for the respective light sources, and
wherein the number-of-emission controlling unit comprises:
a pulse generating circuit that continually generates (M+n) pulses for driving the light sources at intervals; and
a pulse supplying circuit that supplies 1st to M-th pulses among the (M+n) pulses to the drive circuits for the respective light sources as pulses for driving the M kinds of different colors, and that selectively supplies each of (M+n)th pulses to one of the drive circuits.

6. The liquid crystal display of claim 3, further comprising a number-of-emission controlling unit that: divides the one-frame period into (M+n) subfields, n being a positive integer; allots an emission by each of the light sources once in the one-frame period; and additionally allots an emission by the light source corresponding to the specific color in the one-frame period, so as to dynamically change the number of emissions with respect to each of the light sources during the one-frame period,

7. The liquid crystal display of claim 6, wherein the light source driving unit comprises drive circuits for the respective light sources, and
wherein the number-of-emission controlling unit comprises:
a pulse generating circuit that continually generates (M+n) pulses for driving the light sources at intervals; and
a pulse supplying circuit that supplies 1st to M-th pulses among the (M+n) pulses to the drive circuits for the respective light sources as pulses for driving the M kinds of different colors, and that selectively supplies each of (M+n)th pulses to one of the drive circuits.

8. The liquid crystal display of claim 1, which determines color information with respect to each of pixels constituting a display image in the one-frame period of the input image signal, and sets a color having a largest occurrence frequency in the display image as the specific color.

9. The liquid crystal display of claim 2, which determines color information with respect to each of pixels constituting a display image in the one-frame period of the input image signal, and sets a color having a largest occurrence frequency in the display image as the specific color.

10. The liquid crystal display of claim 3, which determines color information with respect to each of pixels constituting a display image in the one-frame period of the input image signal, and sets a color having a largest occurrence frequency in the display image as the specific color.

11. The liquid crystal display of claim 2, which determines color information with respect to each of pixels constituting a display image in the one-frame period of the input image signal, and sets a color having a largest occurrence frequency in the display image as the specific color.

12. The liquid crystal display of claim 3, further comprising an image quality-adjusting unit that subjects a display image in the one-frame period of the input image signal to color enhancement processing for increasing a gain of the specific color.

13. The liquid crystal display of claim 1, wherein the light source driving unit changes a light emitting state of the light source corresponding to the specific color in a specific portion of the display image so as to perform color enhancement processing for forming an emission intensity distribution.

14. The liquid crystal display of claim 2, wherein the light source driving unit changes a light emitting state of the light source corresponding to the specific color in a specific portion of the display image so as to perform color enhancement processing for forming an emission intensity distribution.

15. The liquid crystal display of claim 3, wherein the light source driving unit changes a light emitting state of the light source corresponding to the specific color in a specific portion of the display image so as to perform color enhancement processing for forming an emission intensity distribution.

16. The liquid crystal display of claim 1, wherein each of time periods of turning on and turning off of the light sources in the subfield is longer than a response time at least one of the rise and fall of the liquid crystal after application of an electric field to the liquid crystal.

17. The liquid crystal display of claim 2, wherein each of time periods of turning on and turning off of the light sources in the subfield is longer than a response time at least one of the rise and fall of the liquid crystal after application of an electric field to the liquid crystal.

18. The liquid crystal display of claim 3, wherein each of time periods of turning on and turning off of the light sources in the subfield is longer than a response time at least one of the rise and fall of the liquid crystal after application of an electric field to the liquid crystal.

19. The liquid crystal display of claim 1, wherein the liquid crystal includes an OCB liquid crystal in a bend alignment.

20. The liquid crystal display of claim 2, wherein the liquid crystal includes an OCB liquid crystal in a bend alignment.

21. The liquid crystal display of claim 3, wherein the liquid crystal includes an OCB liquid crystal in a bend alignment.
